(19) United States
(12) Patent Application Publication
(10) Pub. No.: US 2018/0231198 A1
(43) Pub. Date: Aug. 16, 2018

(54) TROFFER LIGHTING SYSTEMS AND METHODS FOR INSTALLING THE SAME

(71) Applicant: Huizhou Light Engine Limited, Huizhou (CN)

(72) Inventor: WA HING LEUNG, Hong Kong (CN)

(73) Assignee: Huizhou Light Engine Limited, Huizhou (CN)

(21) Appl. No.: 15/893,337

(22) Filed: Feb. 9, 2018

Related U.S. Application Data
(60) Provisional application No. 62/457,938, filed on Feb. 12, 2017.

(51) Int. Cl. F21S 8/02; F21V 17/10; F21V 17/12; F21V 23/00; F21V 3/00

(52) U.S. Cl. CPC F21S 8/026; F21V 17/107; F21Y 2115/10; F21V 23/001; F21V 3/00; F21V 17/12

(57) ABSTRACT

Troffer lighting systems can include a lighting panel having one or more light sources and one or more wing portions coupled to the lighting panel. The wing portions can be configured as reflectors to reflect light emitted by the one or more light sources. The wing portions (or reflectors) can be rotatably and/or hingedly coupled to the lighting panel. The coupled wing portions can be movable between a closed and opened position relative to the lighting panel. The closed position reduces the overall size of the troffer lighting system compared to the opened position, and the system is operable while in the opened position. Method of installing a troffer lighting systems is also included.

### CROSS-REFERENCE TO RELATED APPLICATIONS

This application claims priority to U.S. Provisional Application No. 62/457,938, filed Feb. 12, 2017, the entirety of which is incorporated herein by reference.

### TECHNICAL FIELD

The present disclosure relates generally to troffer lighting systems, including troffer-style lighting systems configured as a collapsible fixture, and methods and uses thereof.

### BACKGROUND

Troffer-style light systems or fixtures are commonly configured to be mounted to or suspended from ceilings, and are used for commercial and industrial lighting. The troffer lighting system may be recessed into the ceiling, such as in a suspended or drop/dropped ceiling. Typically, the backside of the troffer protrudes into the area (such as a plenum area) above the suspended ceiling in such configurations. Troffer fixtures can include one or more light sources, such as incandescent lighting, fluorescent lighting (e.g., tube lighting), and/or one or more light-emitting diode (LED) sources.

Troffer fixtures can take many shaped configurations, but typically are formed as square or rectangular structures, and sized for conventional suspended or drop/dropped ceilings.

Presently, due to the large dimensions of the troffer fixtures, storage, packaging and shipping of the troffer fixtures require similarly large storage and shipping/package containers for troffer fixtures that are shipped as an assembled or partially assembled system. This can present challenges as storage, packaging and/or shipping costs rise. Alternatively, the troffer fixtures can be packaged and shipped as disassembled parts to reduce the overall size but require extensive time and necessary tools to assemble the troffer fixture prior to or during installation of the troffer fixture. Further, the packaging cost can be high since additional packing material is required to protect each disassembled part of the troffer fixture.

Accordingly, there exists a need to provide a troffer lighting system that can be stored, packaged, and/or shipped while having reduced dimensions and while limiting, reducing, and/or eliminating the need for tooled assembly before and/or during installation of the system.

### SUMMARY

In consideration of the above problems, in accordance with one aspect disclosed herein, a lighting system such as a troffer lighting system comprises a lighting panel having one or more light sources, and at least one wing portion or reflector moveably (e.g., rotatably or slidably) coupled to the lighting panel. The at least one wing portion or reflector is moveable between a closed position during installation and an open position after installation or during operation.

For example, in some embodiments, an exemplary troffer lighting system includes a first wing portion hingedly coupled to a first side of the lighting panel, and a second wing portion hingedly coupled to a second side of the lighting panel. The first and the second wing portions are moveable between a closed position and an open position.

In an exemplary embodiment, the troffer lighting system includes the open position corresponding to an operable arrangement of the troffer lighting system.

In an exemplary embodiment, the troffer lighting system further comprises a first and a second end caps. The first end cap is configured to engage with a first end of the lighting panel and the first and the second wing portions. The second end cap is configured to engage with a second end of the lighting panel and the first and the second wing portions. The first end of the lighting panel is opposite to the second end of the lighting panel.

In an exemplary embodiment, the troffer lighting system further comprises a first connector that is configured to hingedly couple the first wing portion to the first side of the lighting panel; and a hinge that is configured to hingedly couple the second wing portion to the second side of the lighting panel.

In an exemplary embodiment, the troffer lighting system includes the first wing portion is configured to rotate about the connector and move laterally from the first side of the lighting panel via the connector.

In an exemplary embodiment, the troffer lighting system includes the first and the second wing portions are reflectors configured to reflect light emitted from the one or more light sources.

In an exemplary embodiment, the troffer lighting system includes the lighting panel comprising a channel, and the first wing portion comprises a coupler configured to hingedly couple the first wing portion to the channel of the lighting panel. The coupler has a connector being configured to travel within the channel.

In an exemplary embodiment, the troffer lighting system includes the channel extends along an end of the lighting panel between the first and the second wing portions.

In accordance with another aspect disclosed herein, a troffer lighting system comprises a lighting panel, which has one or more light sources and a channel extending along a first end of the lighting panel and between first and second sides of the lighting panel. The first side is opposite to the second side. The first wing reflector is adjacent to the first side of the lighting panel and moveably (e.g., rotatably) coupled to the lighting panel via a connector configured to connect with the channel. The connector being configured to travel along and rotate within the channel.

In an exemplary embodiment, the troffer lighting system further comprises a second wing reflector rotatably coupled to the second side of the lighting panel.

In an exemplary embodiment, the troffer lighting system includes the first and the second wing reflectors are moveable between a closed position and an open position.

In an exemplary embodiment, the troffer lighting system includes the open position corresponding to an operable arrangement of the troffer lighting system.

In an exemplary embodiment, the troffer lighting system further comprises a second wing reflector fixedly coupled to the second side of the lighting panel.

In an exemplary embodiment, the troffer lighting system further comprises an end cap that is configured to engage with the first end of the lighting panel and the first wing reflector.

In an exemplary embodiment, the troffer lighting system includes the first wing reflector comprises a coupler engaged with the connector. The coupler is configured to rotatably couple the first wing reflector to the lighting panel.

In accordance with another aspect disclosed herein, a method of installing a troffer lighting system is provided. The lighting system includes a first and a second end caps, and a first and a second wing portions coupled to a lighting panel, which has one or more light sources. The method comprises mounting the first and the second end caps to support beams of a drop ceiling; connecting the second wing portion to the first and the second end caps; rotating the lighting panel with respect to the second wing portion to connect the lighting panel to the first and the second end caps; and rotating the first wing portion with respect to the lighting panel to connect the first wing portion to the first and the second end caps.

In an exemplary embodiment, the method further comprises moving the first wing portion away from the lighting panel to engage an end of the first wing portion with respective ends of the first and the second end caps to connect the first wing portion to the first and the second end caps.

In an exemplary embodiment, the method further comprises adjusting the troffer lighting system from a closed position to an open position to access the first and the second end caps.

In an exemplary embodiment, in such a method, the first wing portion and the second wing portion are each hingedly coupled to the lighting panel. The lighting panel is configured to rotate about the hinged coupling with the second wing portion to connect the lighting panel to the first and the second end caps. The first wing portion is configured to rotate about the hinged coupling with the lighting panel to connect the first wing portion to the first and the second end caps.

In an exemplary embodiment, in such a method, the first and the second end caps are mounted in a drop ceiling.

In an exemplary embodiment, the troffer lighting system and methods can include one or more light sources comprising one or more LED sources.

In accordance with another aspect disclosed herein, a troffer lighting system includes a lighting panel having one or more light sources; a first wing portion fixedly coupled to the lighting panel; and a second wing portion hingedly coupled to the lighting panel. The second wing portion is movable between a closed position and an open position.

In an exemplary embodiment, the troffer lighting system further includes a first and a second end caps. The first end cap is configured to engage with a first end of the lighting panel and a first end of the first and second wing portions. The second end cap is configured to engage with a second end of the lighting panel and a second end of the first and the second wing portions. The first end of the lighting panel is opposite to the second end of the lighting panel.

In an exemplary embodiment, the first wing portion comprises a medial portion adjacent to the lighting panel, and a lateral portion opposite to the medial portion. At the first end of the first wing portion, the lateral portion is configured to interlock with the first end cap. At the second end of the first wing portion, the lateral portion is configured to interlock with the second end cap.

In an exemplary embodiment, the first wing portion comprises a first locking tab at the lateral portion of the first end of the first wing portion, and a second locking tab at the lateral portion of the second end of the first wing portion. The first locking tab is configured to engage a slot defined in the first end cap. The second locking tab is configured to engage a slot defined in the second end cap. In an exemplary embodiment, the troffer lighting system includes a first locking screw configured to couple the lighting panel and the first end cap.

In an exemplary embodiment, the troffer lighting system includes a second locking screw configured to couple the lighting panel and the second end cap.

In an exemplary embodiment, the lighting panel includes a channel, and the second wing portion includes a coupler having a connector coupled to the channel and being slidable therein.

In an exemplary embodiment, the channel includes a first leg connected to a second leg by a transition portion. The first leg is below the second leg. The hinge is disposed within the first leg when the troffer lighting system is in the closed position, and the hinge is disposed within the second leg when the second wing portion is in the open position.

In an exemplary embodiment, the first leg and the second leg are parallel to each other.

In an exemplary embodiment, the troffer lighting system further includes a locking mechanism. With the locking mechanism in a first configuration, the second wing portion is able to rotate with respect to the lighting panel. With the locking mechanism in a second configuration, the second wing portion is prevented from rotating with respect to the lighting panel.

In an exemplary embodiment, the locking mechanism includes a lock rotatably coupled to the second wing portion. The lock includes an arm configured to engage the lighting panel to prevent relative rotation of the second wing portion.

In accordance with another aspect disclosed herein, a method of installing a troffer lighting system in a drop ceiling, includes the steps of: connecting a first end cap to a first end of a lighting panel; connecting the first end cap to a first wing portion fixedly coupled to the lighting panel; mounting a second end cap into a grid of the drop ceiling; connecting a second end of the lighting panel to the second end cap; rotating a second wing portion from a closed position to an open position so as to engage the second wing portion with the first end cap and the second end cap; and connecting a lens to the lighting system.

In an exemplary embodiment, the step of connecting the first end cap to the first end of the lighting panel includes coupling the lighting panel to the first end cap with a first locking screw.

In an exemplary embodiment, the step of connecting the second end cap to the second end of the lighting panel includes coupling the lighting panel to the second end cap with a second locking screw.

In an exemplary embodiment, the method further includes moving a locking mechanism from a first configuration to a second configuration so as to prevent rotation of the second wing portion with respect to the lighting panel.

In another aspect describe herein, a troffer lighting system includes a lighting module and a reflector assembly. The reflector assembly includes: a first reflector; a second reflector; a first rail coupled to a first end of the first and second reflectors; and a second rail coupled to a second end of the first and second reflectors. The second end is opposite to the first end. A longitudinal axis is defined between the first end and the second end. Either or both of the first and the second reflectors are moveable (e.g., slidably) from a collapsed (close) configuration to an extended (open) configuration. For example, in some embodiments, the second reflector is movable from a collapsed configuration to an extended configuration. The second reflector is axially translatable in a direction orthogonal to the longitudinal axis. The lighting module is configured to removably couple to the reflector assembly.

In an exemplary embodiment, the troffer lighting system further includes a first and a second end caps. The first end cap is configured to engage with the first end of the first and second reflectors. The second end cap is configured to engage with the second end of the first and second reflectors.

In an exemplary embodiment, at least one of the first and second reflectors includes a hook extending from a bottom surface of the at least one of the first and the second reflectors. The hook is configured to engage the first end cap such that the first end cap is securely engaged with the at least one of the first and the second reflectors.

In an exemplary embodiment, each of the first and second reflectors includes a medial portion and a lateral portion. At the first end of each of the first and second reflectors, the lateral portion is configured to interlock with the first end cap. At the second end of each of the first and second reflectors, the lateral portion is configured to interlock with the second end cap.

In an exemplary embodiment, the first end cap defines a slot. At least one of the first and second reflectors includes a first locking tab. The slot of the first end cap and the first locking tab are configured to interlock with each other.

In an exemplary embodiment, the first end cap includes an extension configured to be oriented parallel to the longitudinal axis. The extension defines the slot.

In an exemplary embodiment, the second end cap defines a slot. The at least one of the first and the second reflectors includes a second projection. The slot of the second end cap and the second locking tab are configured to interlock to secure the end cap to the at least one of the first and the second reflectors.

In an exemplary embodiment, the first end cap includes a locking mechanism to secure the first end cap to the first reflector. The locking mechanism includes a lock rotatably coupled to the first end cap, and is configured to rotate from an unlocked position to a locked position. An arm of the lock is configured to pass through an opening of the first reflector and engage an upper side of the first reflector.

In an exemplary embodiment, the opening has a width parallel to the longitudinal axis. The lock is rotatable about a rotational axis that is parallel to the longitudinal axis. The lock includes a thickened portion that has a thickness parallel to the longitudinal axis, which is greater than the width of the opening. The thickened portion is configured to pass through the opening and be disposed above the first reflector when the first end cap is engaged with first reflector and the lock is in the locked position.

In an exemplary embodiment, at least one of the first and the second reflectors defines a window, the lighting module includes an arm configured to pass through the window and engage the at least one of the reflectors.

In an exemplary embodiment, the lighting module includes an aperture aligned with a portion of the arm such that a tool can be inserted through the aperture to deflect the arm to disengage the lighting module from the reflector assembly.

In an exemplary embodiment, each of the first and second reflectors includes a locking mechanism configured to lock the respective reflector in the extended configuration.

In an exemplary embodiment, the locking mechanism includes a cantilever tab. The cantilever tab is configured to engage either the first rail or the second rail when the respective reflector is in the extended configuration.

According to another aspect described herein, a method of installing a troffer lighting system as described is provided. Such a method includes: installing a reflector assembly onto a drop ceiling. The reflector assembly comprises a first reflector, a second reflector, a first rail coupled to a first end of the first and the second reflectors, and a second rail coupled to a second end of the first and the second reflectors. The second end is opposite to the first end. A longitudinal axis is defined between the first end and the second end. The method further comprises moving the second reflector from a collapsed configuration to an extended configuration. The second reflector is axially translatable in a direction orthogonal to the longitudinal axis. The method further comprises connecting a first end cap to the first end of the first and the second reflectors; connecting a second end cap to the second end of the first and the second reflectors; and connecting a lighting module to the reflector assembly.

In an exemplary embodiment, the method further includes locking the first reflector in the extended configuration by inserting a cantilever tab of the first reflector into the first bracket.

In an exemplary embodiment, the step of connecting the first end cap to the first end of the reflector assembly includes rotating a lock about an axis parallel to the longitudinal axis such that a portion of the lock passes through an opening of the first reflector such that an arm of the lock is disposed above the first reflector.

In an exemplary embodiment, the step of connecting the first end cap to the first end of the reflector assembly further includes interlocking a lateral portion of the first reflector with the first end cap.

In an exemplary embodiment, the step of connecting the first end cap to the first end of the reflector assembly includes engaging a first slot of the first end cap with a first locking tab of the first reflector, and engaging a second slot of the first end cap with a first locking tab of the second reflector.

In an exemplary embodiment, the step of connecting the second end cap to the second end of the reflector assembly includes engaging a first slot of the second end cap with a second locking tab of the first reflector, and engaging a second slot of the second end cap with a second locking tab of the second reflector.

In an exemplary embodiment, the step of connecting the lighting module to the reflector assembly includes passing an arm of the lighting module through a window defined by the reflector assembly such that a portion of the arm engages a top surface of the reflector assembly.

In an exemplary embodiment, the method further includes connecting a safety strap between the lighting module and the reflector assembly.

### BRIEF DESCRIPTION OF THE FIGURES

The accompanying figures, which are incorporated herein and form a part of the specification, illustrate the embodiments of the present disclosure and, together with the description, further serve to explain the principles of the embodiments and to enable a person skilled in the pertinent art to make and use the embodiments. The figures are for illustration purposes only and are not necessarily drawn to scale.

FIG. 1A illustrates a perspective view of a troffer lighting system according to an exemplary embodiment of the present disclosure.

FIG. 1B illustrates a perspective view of a troffer lighting system according to another exemplary embodiment of the present disclosure.

FIG. 2A illustrates a bottom view, of the troffer lighting system of FIG. 1A.

FIG. 2B illustrates a first side view of the troffer lighting system of FIG. 1A.

FIG. 2C illustrates a second side view of the troffer lighting system of FIG. 1A.

FIG. 3A illustrates a bottom view of the troffer lighting system of FIG. 1B.

FIG. 3B illustrates a first side view of the troffer lighting system of FIG. 1B.

FIG. 3C illustrates a second side view of the troffer lighting system of FIG. 1C.

FIG. 4A illustrates a perspective view of a troffer lighting system according to an exemplary embodiment of the present disclosure.

FIG. 4B illustrates an enlarged view of a portion of the troffer lighting system of FIG. 4A.

FIGS. 5-10 illustrate views of a troffer lighting system and the assembly of the troffer lighting system according to exemplary embodiments of the present disclosure.

FIGS. 11A-14B illustrate a troffer lighting system in closed configurations according to exemplary embodiments of the present disclosure.

FIG. 15 illustrates an isometric view of another embodiment of a troffer lighting system of the present disclosure.

FIG. 16 is an exploded view of the troffer lighting system of FIG. 15.

FIG. 17 is a detail bottom isometric view of the troffer lighting system of FIG. 15.

FIG. 18 is a detail top isometric view of the troffer lighting system of FIG. 15.

FIG. 19 is a detail top isometric view of a lighting panel and locking mechanism according to one embodiment of the present disclosure.

FIG. 20 illustrates an interlock formed between an end cap and a wing portion.

FIG. 21 illustrates a locking tab of a wing portion.

FIG. 22 illustrates an extension of an end cap defining a slot for receiving a locking tab.

FIG. 23A illustrates the troffer lighting system of FIG. 15 in a closed configuration.

FIG. 23B illustrates a detail view of a channel of a lighting panel and a wing portion in the closed configuration.

FIG. 24A illustrates the troffer lighting system of FIG. 15 in an open configuration.

FIG. 24B illustrates a detail view of a channel of a lighting panel and a wing portion in the open configuration.

FIG. 25 illustrates a lock according to one embodiment of the present disclosure in an unlocked configuration.

FIG. 26 illustrates the lock of FIG. 25 in a locked configuration.

FIG. 27 illustrates the top portion of the lock of FIG. 25 in the locked configuration.

FIG. 28 illustrates a connector according to one embodiment of the present disclosure.

FIGS. 29A-29E illustrate certain steps of installation of the troffer lighting system of FIG. 15.

FIG. 30 illustrates a troffer lighting system according to another embodiment of the present disclosure.

FIG. 31 illustrates an exploded view of the troffer lighting system of FIG. 30.

FIG. 32 illustrates an isometric end view of a reflector assembly according to one embodiment of the present disclosure.

FIG. 33 illustrates an end view of a rail according to one embodiment of the present disclosure.

FIG. 34 illustrates a side view of the rail of FIG. 33.

FIG. 35 illustrates a top view of a cantilever tab of a reflector of the troffer lighting system of FIG. 30.

FIG. 36 illustrates a bottom isometric view of a reflector of the troffer lighting system of FIG. 30.

FIG. 37 is a detail view of a hook of a reflector of the troffer lighting system of FIG. 30.

FIG. 38 is an isometric view of the hook of FIG. 37 engaged with an end cap.

FIG. 39 illustrates a lock of an end cap in a locked configuration.

FIG. 40 illustrates the lock of FIG. 39 in an unlocked configuration.

FIG. 41 illustrates the top of the lock of FIG. 39 when in the locked configuration.

FIG. 42 illustrates an interlock between an end cap and a reflector according to one embodiment of the present disclosure.

FIG. 43 illustrates a detail view of an extension of an end cap according to one embodiment of the present disclosure.

FIG. 44 illustrates a detail view of a locking tab of a reflector according to one embodiment of the present disclosure.

FIG. 45 illustrates an isometric view of an end cap according to one embodiment of the present disclosure.

FIG. 46 illustrates an arm of a lighting panel configured for engaging a reflector.

FIG. 47 illustrates the arm of FIG. 46 engaged with a reflector.

FIGS. 48A-48D illustrate certain steps of installing the troffer lighting system of FIG. 30.

The exemplary embodiments of the present disclosure will be described with reference to the accompanying drawings. The drawing in which an element first appears is typically indicated by the leftmost digit(s) in the corresponding reference number.

### DETAILED DESCRIPTION

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively or operably connected” is such an attachment, coupling or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

In the following description, numerous specific details are set forth in order to provide a thorough understanding of the embodiments of the present disclosure. However, it will be apparent to those skilled in the art that the embodiments, including structures, systems, and methods, may be practiced without these specific details. In other instances, well-known methods, procedures, components, and circuitry have not been described in detail to avoid unnecessarily obscuring embodiments of the disclosure.

The troffer lighting systems discussed herein solve the need for a troffer lighting system that can be stored, packaged, and/or shipped while having reduced dimensions and while limiting, reducing, and/or eliminating the need for tooled assembly before and/or during installation of the system. As discussed further below, the troffer lighting systems discussed herein help decrease storage, packaging and shipping costs due to their ability to fold or collapse to fit within a relatively compact space and with minimal disassembled parts. Additionally, the troffer lighting systems discussed herein are also easy to assemble, and help decrease time and cost in assembling and installing such systems. Although certain of the embodiments of the troffer light systems described herein and shown in the accompanying figures are square or rectangular in shape, the lighting systems can be any appropriate shape and size. For example, the lighting systems can be circular, oval, or any other appropriate shape. “Troffer” as used herein indicates that the lighting system is configured to be recessed within a portion of a ceiling and does not restrict the size or shape of the embodiments described.

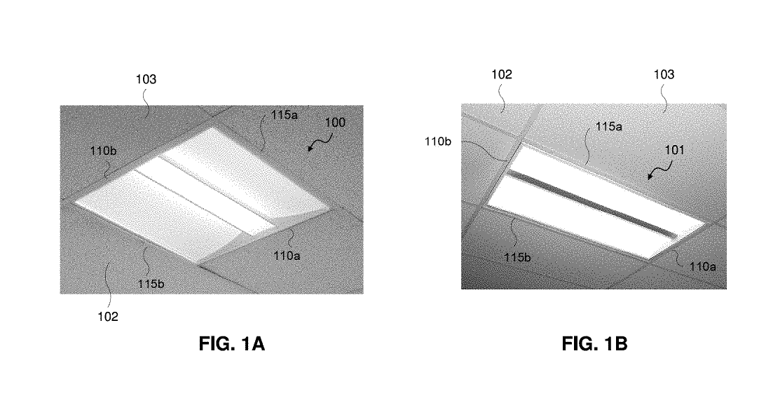

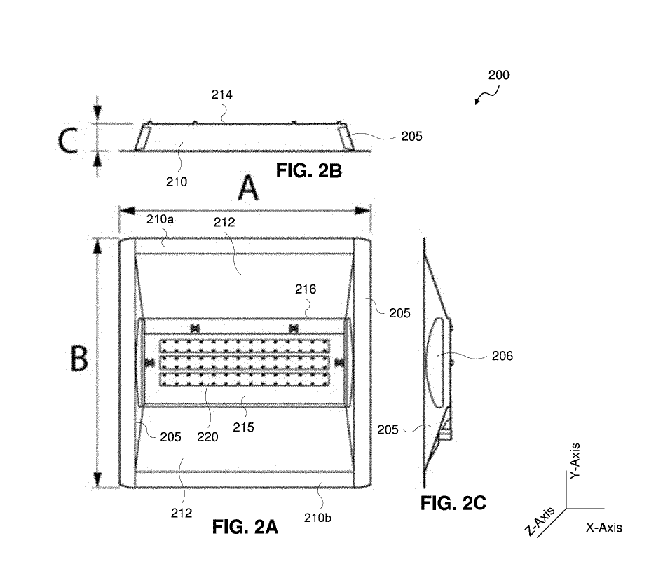

FIGS. 1A and 1B illustrate troffer lighting systems 100 and 101, respectively, according to exemplary embodiments of the present disclosure. The troffer lighting systems 100, 101 are configured to be mounted in a ceiling 102. As shown in FIGS. 1A and 1B, the troffer lighting systems 100 and 101 are recessed into a suspended or drop/dropped ceiling 102. In this configuration, the backside of the troffer protrudes into the area (such as a plenum area) above the suspended ceiling 102. The troffer lighting system 100 is square and configured to fit in a square tile of the suspended ceiling 102 while the troffer lighting system 101 is rectangular to fit in a rectangular tile. In an embodiment, the lighting system 101 is twice as large as the lighting system 100. For example, the lighting system 100 can be configured as a 2 feet×2 feet (0.61 meter×0.61 meter) fixture (e.g., lengths A and B are equal, as shown in FIG. 2A) that would span a single tile of a suspended ceiling 102. The lighting system 101 can be also configured as a 2 feet×4 feet (0.61 meter×1.22 meter) fixture (e.g., length A is 2× length B) that would span two adjacent tiles of the suspended ceiling. The tiles and lighting systems 100, 101 are supported by a support grid formed from longitudinal support beams 110a & 110b and transverse support beams 115a & 115b. The longitudinal support beams 110a & 110b and transverse support beams 115a & 115b are arranged to form a grid pattern that is secured to the structural ceiling of the building and suspended below the structural ceiling. The grid pattern includes voids that are configured to accept tiles 103 (and/or partial tiles 103) and lighting system 100, 101 to form the suspended ceiling 102.

The troffer lighting systems 100 and 101 may be suspended or fit-mounted within the ceiling 102. The view of the troffer lighting systems 100 and 101 in FIGS. 1A-1B is from an area underneath the troffer lighting systems 100 and 101 (i.e., the area that would be lit by the one or more light sources housed within the troffer lighting systems 100 and 101). The one or more light sources can be, for example, incandescent lighting, fluorescent lighting (e.g., tube lighting), one or more light emitting diode (LED) sources, or a combination thereof. Such LED sources can be LED strip lighting, one or more individual LEDs, one or more LED panels, LED tube lighting, or a combination thereof.

The troffer lighting systems 100 and 101 may be mounted in the ceiling 102 such that the troffer lighting systems 100 and 101 are flush with the plane formed by the ceiling 102. In this configuration, the top portion of the troffer lighting systems 100 and 101 would protrude into the area (such as plenum area) above the ceiling 102.

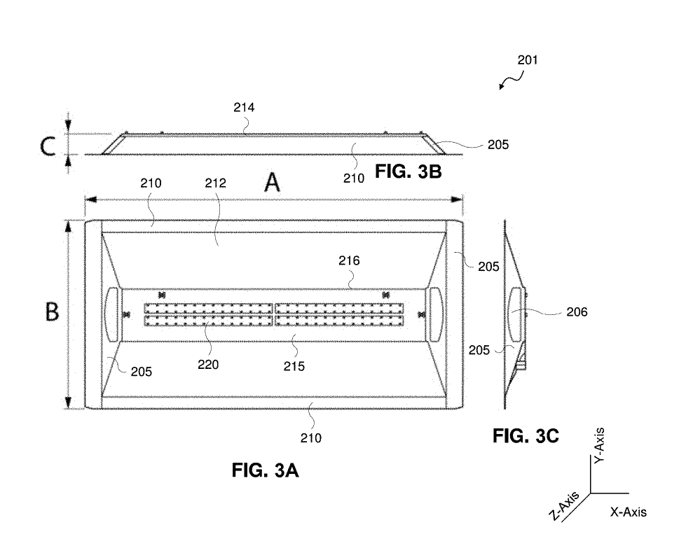

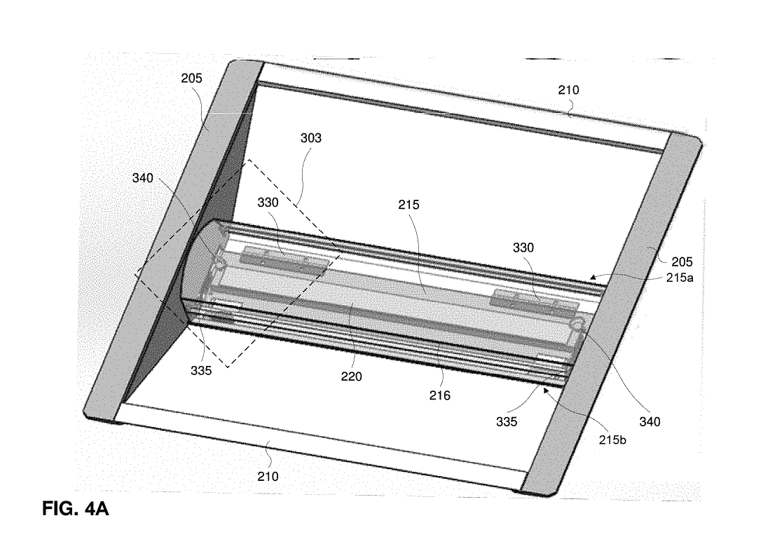

Turning to FIGS. 2A-2C and 3A-3C, troffer lighting systems 200 and 201 according to exemplary embodiments are illustrated. The troffer lighting systems 200 and 201 can be embodiments of the troffer lighting systems 100 and 101, respectively. FIGS. 2A and 3A show bottom plan views (e.g., the side in which light is generated) of the troffer lighting systems 200 and 201, respectively. FIGS. 2B and 3B show a side view taken along the Y-axis of the troffer lighting systems 200 and 201. FIGS. 2C and 3C show a side view taken along the X-axis of the lighting systems 200 and 201. The view taken along the Y-axis (e.g., FIG. 2B) shows the back surface of the lighting system 200, 201 (e.g., the back 214 of the lighting panel 215) and the back surface of a wing portion 210. The view taken along the X-axis (e.g., FIG. 2C) shows the outside surface of the end cap 205.

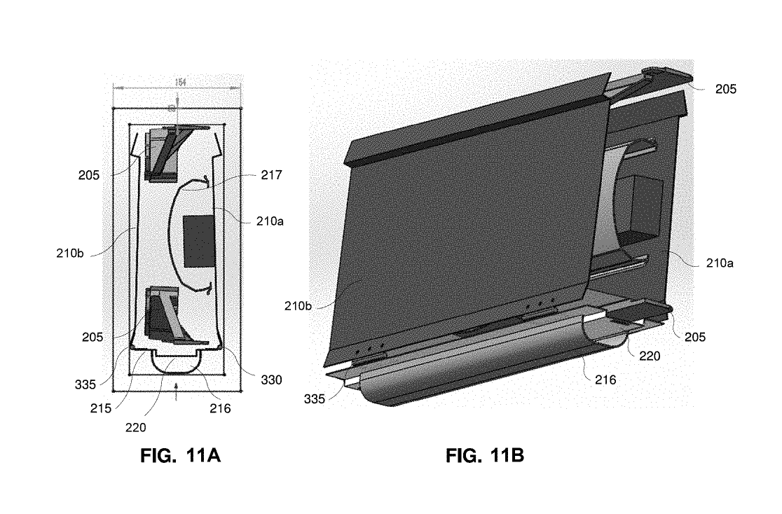

The troffer lighting systems 200, 201 can include a lighting panel (or light engine) 215 and two or more wing portions 210 connected to the lighting panel 215. The wing portions 210 can be also referred to as wings, reflectors, and/or reflecting portions. The wing portions 210 can be rotatably connected to the lighting panel 215. The wing portions 210 can be hingedly connected to the lighting panel 215 via one or more hinged fasteners, such as one or more hinges, and configured to rotate about the connection to the lighting panel 215. In operation, the wing portions 210 can be moved from a closed position to an opened position (e.g., the wing portions 210 can be opened). The opened configuration is illustrated in FIGS. 1A-4A. The opened and closed position is analogous to the opened and closed positions of a book, where the book covers correspond to the wing portions 210 and the binding of the book corresponds to the lighting panel 215. Closed or folded positions of the lighting systems 200, 201 are illustrated in FIGS. 11A-14B.

In exemplary embodiments, the hinged connection can also be configured to facilitate a respective wing portion 210 to move laterally inward and outward to/from the lighting panel 215. That is, as discussed in detail below, the axis of rotation in which the wing portion 210 is rotatable can move toward and away from the lighting panel 215. This movement can also be in a direction parallel to a plane formed by the lighting panel 215 (i.e., the plane of the ceiling) through a movement inside a channel 342. Examples of the hinged connection are discussed below.

In an embodiment, one or more of the wing portions 210 are connected to the lighting panel 215 via a flexible connector that allows the wing portion(s) 210 to rotate about the connection to the lighting panel 215. The wing portions 210 can be removable in one or more embodiments. As will be described further herein, the connector can include be a portion of a hinge rotatably coupling the wing portions 210 to the lighting panel 215.

The wing portions 210, as well as the other wing portions described herein, can be configured to reflect and/or refract light generated by the light source(s) 220. For example, the surface 212 of the wing portion 210 can be reflective. The wing portions 210 can be faceted or have one or more faceted surfaces. In other embodiments, the wing portions 210 are faceted to create a bent or curved shape. The wing portions 210 can have a smooth surface in other embodiments. The wing portions 210 can be curved, flat, parabolic, and/or have another shape as would be understood by one of ordinary skill in the art. The wing portions 210 can be made of metal, plastic, one or more composite materials, and/or one or more other materials as would be understood by one of ordinary skill in the art. The wing portions 210 can be configured as a heat sink that dissipates heat, from, for example, the light sources 220.

The lighting panel 215 of the troffer lighting systems 200, 201 includes one or more light sources 220. The light sources 220 can include one or more incandescent light sources, one or more fluorescent light sources (e.g., fluorescent tube light bulbs), one or more LED sources, and/or one or more other light sources as would be understood by one of ordinary skill in the art. Such LED sources can be LED strip lighting, one or more individual LEDs, one or more LED panels, LED tube lighting, or a combination thereof.

The lighting panel 215 can be made of metal, plastic, one or more composite materials, and/or one or more other materials as would be understood by one of ordinary skill in the art. The lighting panel 215 can be configured as a heat sink to dissipate heat generated by, for example, one or more of the light sources 220. The lighting panel 215 can be partially or completely reflective and/or refractive in one or more embodiments.

The lighting panel 215 can be covered with a lens 216. The lens 216 can be transparent or translucent. In an embodiment, the lens 216 can be configured as a diffuser that is configured to diffuse light generated by the light sources 220. An additional lens 217 can be disposed over the lens 216.

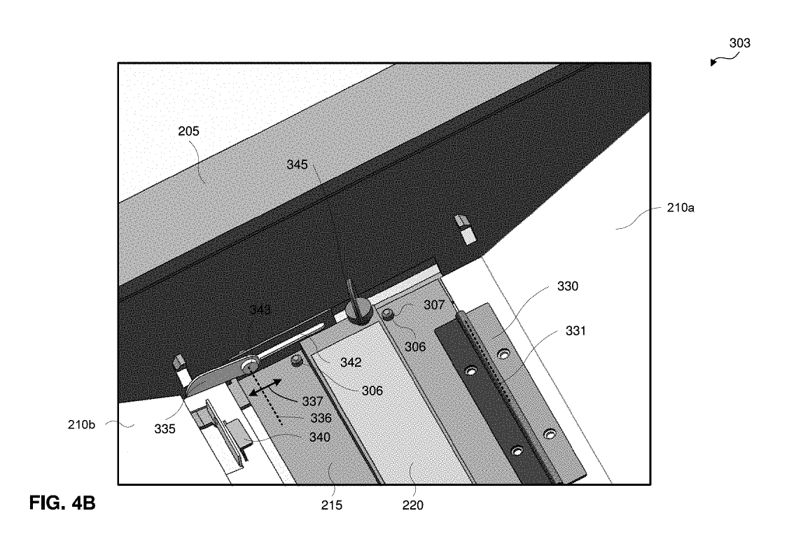

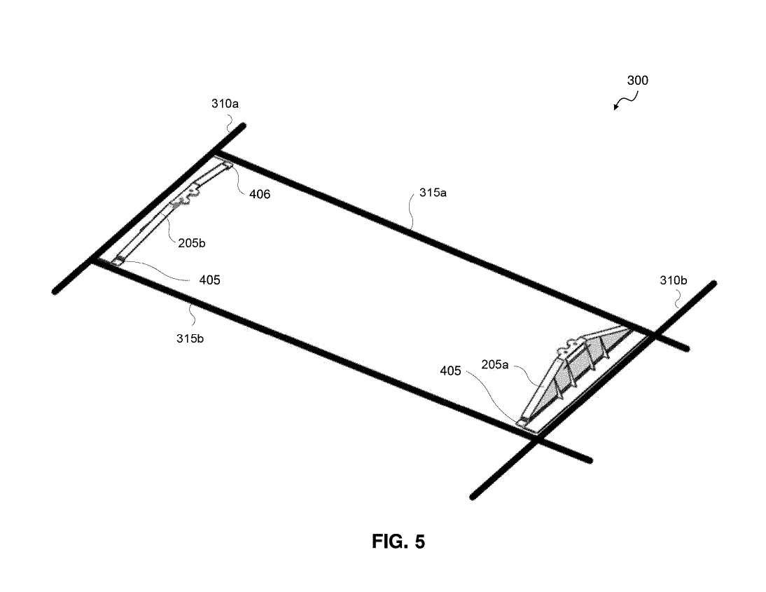

The lighting panel 215 and wing portions 210 can be connected with one or more end caps 205. The light panel 215 and wing portions 210 can be configured to releasably connect to the end cap(s) 205 to form the troffer lighting systems 200, 201. For example, the lighting panel 215 can releasably connect to the end cap 205 via locking mechanism 345 (FIGS. 4A and 4B). Further, as illustrated in FIGS. 5 & 6, ends 505 and 506 of the wing portions 210 can be configured to mate with and connect to ends 405 and 406 of the end cap 205, respectively. As shown in FIGS. 2A and 3A, the lighting panel 215 and wing portions 210 are connected to the two end caps 205. The end caps 205 can be made of metal, plastic, one or more composite materials, and/or one or more other materials as would be understood by one of ordinary skill in the art. The end caps 205 can be configured as a heat sink to dissipate heat generated by, for example, one or more of the light sources 220. The end caps 205 can be partially or completely reflective and/or refractive in one or more embodiments. The end caps 205 can include a connector (e.g., a projection or recess) that is configured to connect to the light panel 215 and/or lens 216.

Turning to FIGS. 4A and 4B, an exemplary embodiment of the lighting systems 200, 201 are illustrated including first hinges 330, coupler 335, and locking mechanisms 340. An enlarged view of a portion 303 of the lighting systems 200, 201 is shown in FIG. 4B.

In an exemplary embodiment, the first wing portion 210a is hingedly connected to a first side 215a of the lighting panel 215 via first hinge 330 having an axis of rotation 331. The second wing portion 210b is hingedly connected to a second side 215b of the lighting panel 215 via the coupler 335 having an axis of rotation 336. The coupler 335 (axis of rotation 336) is movable toward and away from the center of the lighting panel 215 (toward and away from the lighting sources 220) in the direction 337 via channel or track 342. In an exemplary embodiment, as shown in FIGS. 4B, 7E, and 9B, the channel 342 can be L-shaped to allow the hinge to travel toward and away from the center of the lighting panel 215 (direction 337) and toward and away from a top surface of the lighting panel 215. For example, the connector 343 of the coupler 335 can be connected to and moveable within the channel 342. When engaging the ends 505 of the second wing portion 210b with the ends 405 of the end cap 205, the connector 343 travels away from the center of the lighting panel 215 in the direction 337. Upon reaching the end of the channel 342 in the direction 337, the connector 343 can travel toward the lighting panel 215 in a direction orthogonal to the direction 337. Alternatively, the second portion of the channel 342 can be at an angle of other than 90 degrees with the first portion of the channel 342.

The lighting panel 215 is configured to engage and releasably connect to the end cap 205 via locking mechanism 345. The locking mechanism 345 can be a hook or other projection that engages with a corresponding receptacle of the end cap 205 to secure the lighting panel 215 to the end cap 205. For example, the locking mechanism 345 can be configured to rotate to engage/disengage the connection with the end cap 205. The lighting panel 215 can include one or more apertures 306 that are configured to accept a corresponding projection 307 of the end cap 205 to secure the lighting panel 215 to the end cap 205. In one or more embodiments, the wing portions 210 and lighting panel 215 are configured to snap together (e.g., a snap fit, a magnetic connection, etc.) with the end caps 205.

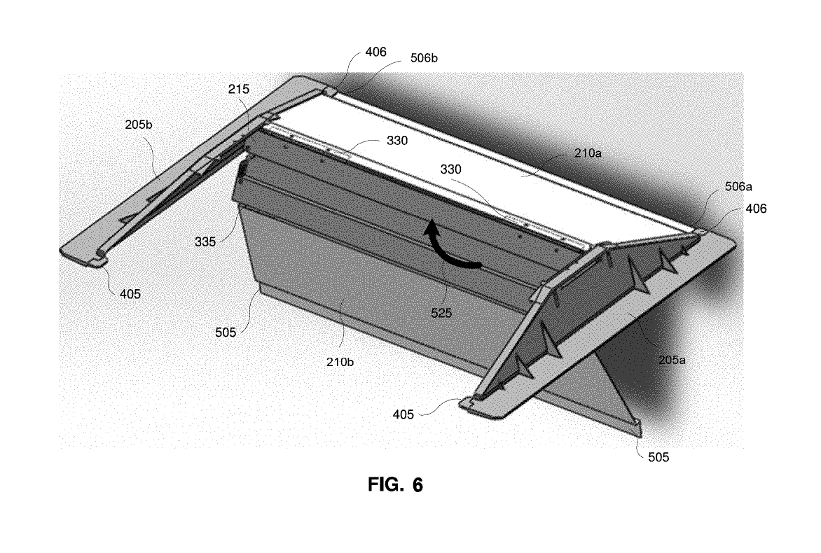

In an exemplary operation, to connect the wing portions 210 and the lighting panel 215 with corresponding end caps 205, the first wing portion 210a can connect with the end cap 205. For example, the ends 506 of the first wing portion 210a can slidably engage the ends 406 of the end caps 205 as shown in FIG. 6.

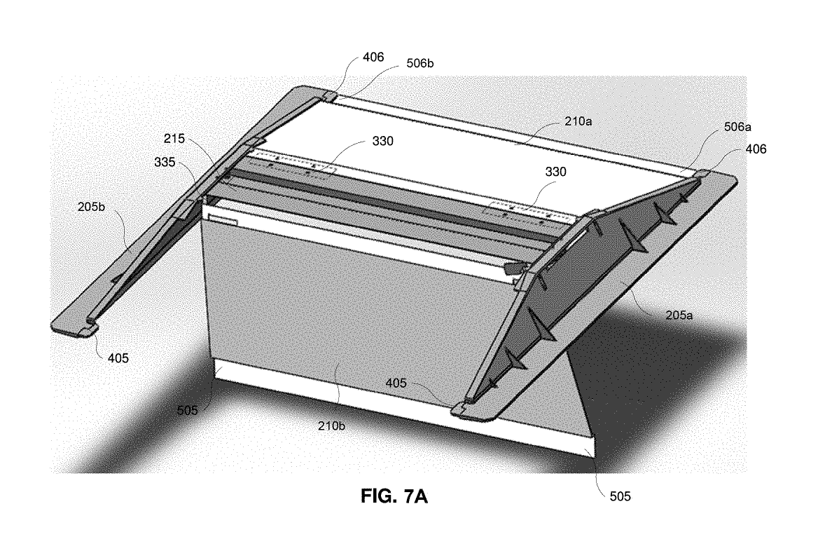

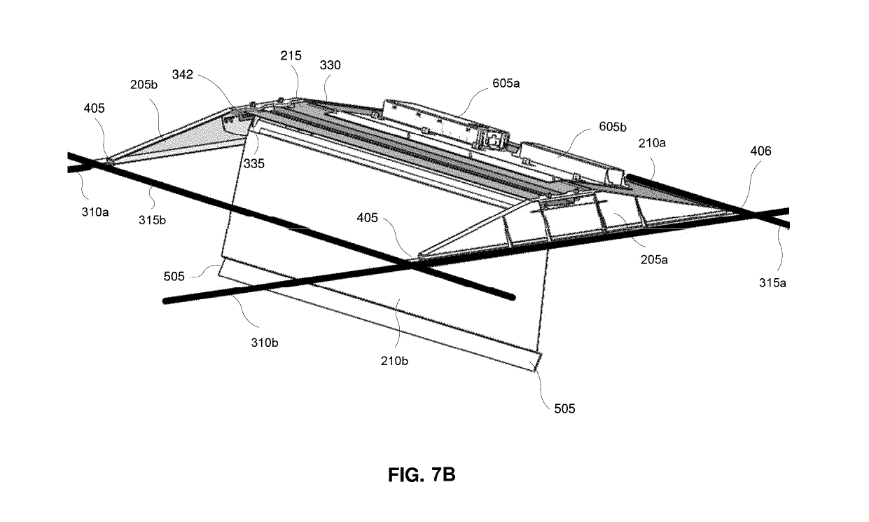

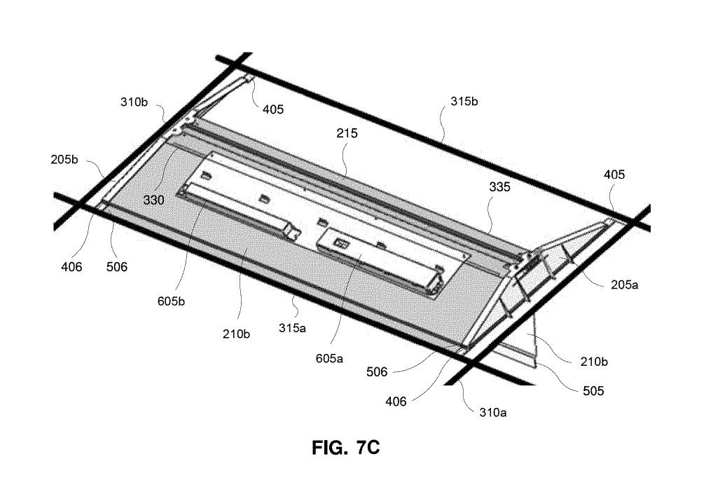

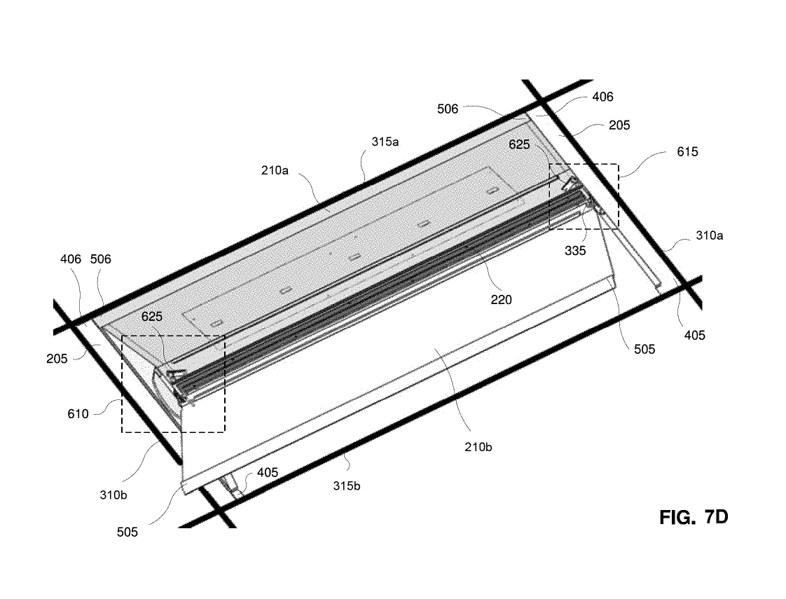

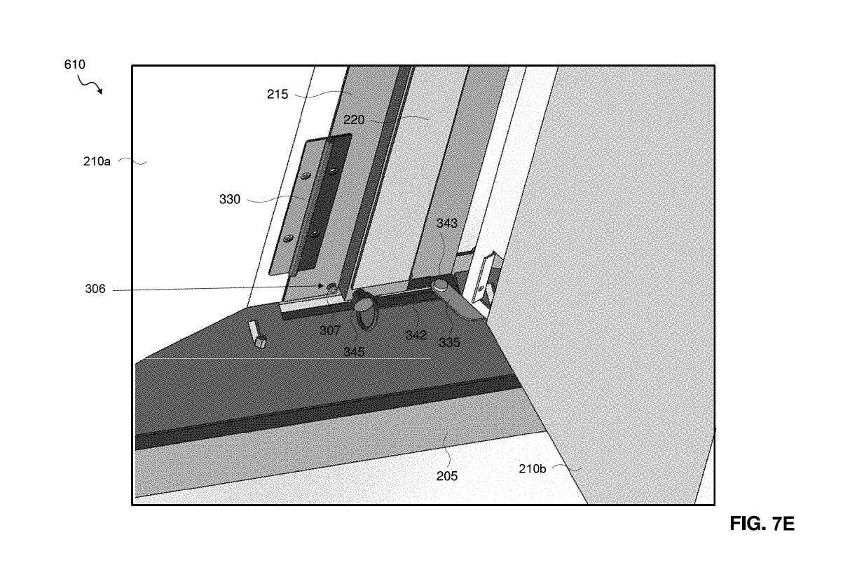

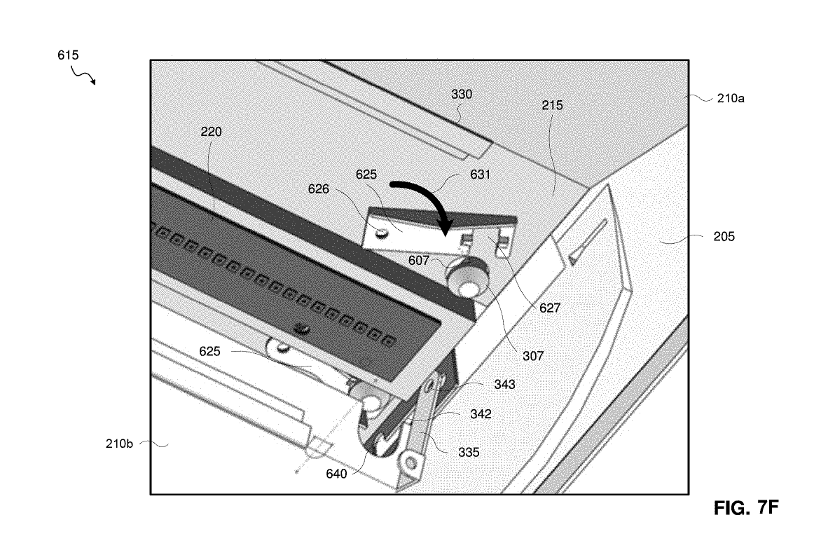

The lighting panel 215 is then brought into communication (by rotating the lighting panel 215 towards the top of the end caps 205 via the hinge 330) with the end cap 205 and secured to the end cap 205 via the locking mechanism 345. FIG. 7A shows the lighting panel 215 being connected with the end caps 205.

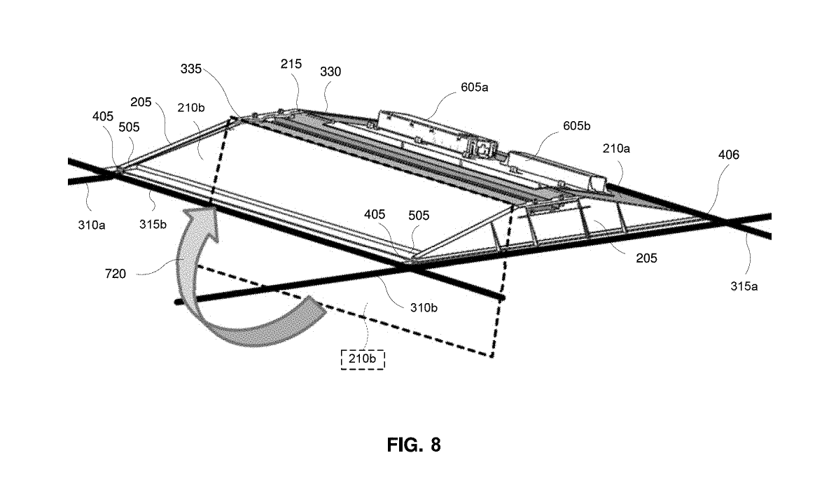

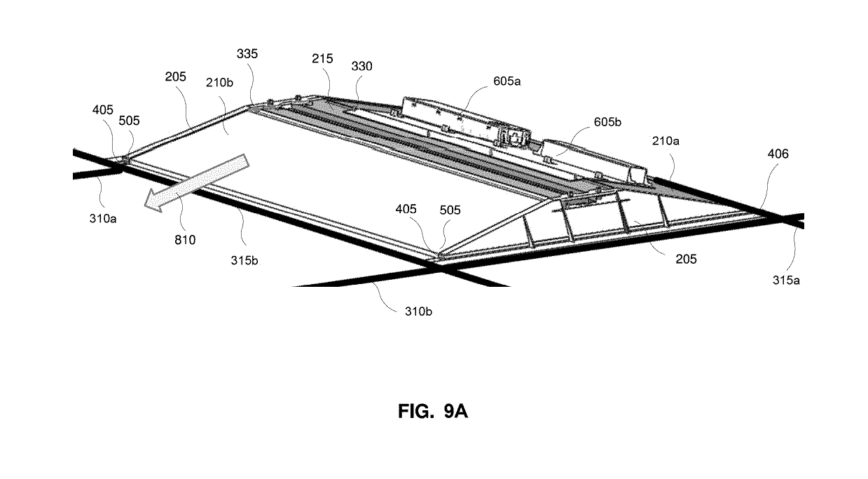

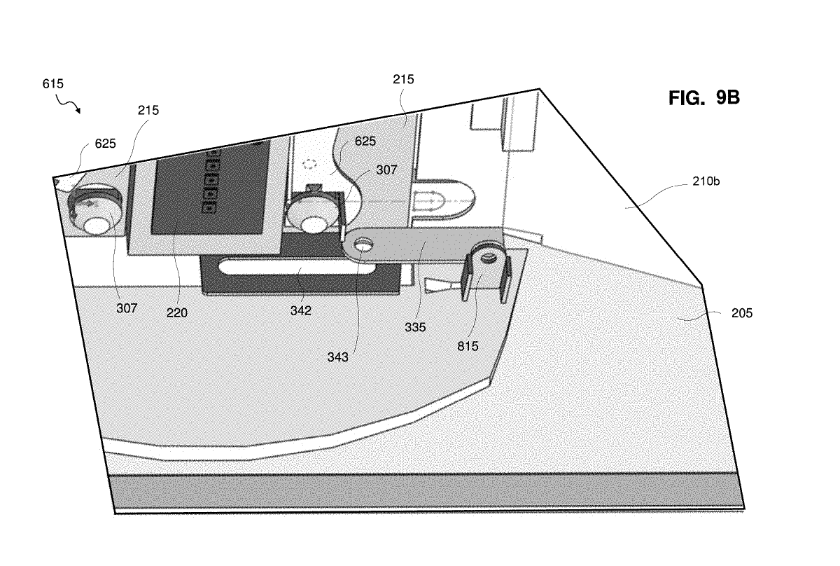

As shown in FIG. 8, the second wing portion 210b is then rotated towards the end caps 205 via the coupler 335, and then moved away from the lighting panel 215 as the coupler 335 is moved in the channel 342 away from the lighting panel 215 such that the ends 505 of the second wing portion 210b engage (e.g., slidably engage) the ends 405 of the end caps 205 (moved in direction 810 shown in FIG. 9A). As the second wing portion 210b moves away from the lighting panel 215, the end (e.g., 505) of the second wing portion 210b engages and secures with the end (e.g., 405) of the end cap 205. The second wing portion 210b can include a locking mechanism 340 (shown in FIG. 4B) that is configured to engage the coupler 335 to lock the coupler 335 in a stationary position. For example, when the second wing portion 210b is connected with the end cap 205, the locking mechanism 340 (FIG. 4B) can engage (e.g., by rotating onto) the coupler 335 to lock the coupler 335 in position. This operation is described in more detail below. In an exemplary embodiment, as shown in FIG. 9B, the coupler 335 can be configured to slidably engage a locking mechanism 815 of the end cap 205 as the second wing portion 210b and coupler 335 are moved away from the lighting panel 215 (in direction 810)

Methods to assemble and install the lighting system 200, 201 according to exemplary embodiments of the present disclosure are illustrated in FIGS. 5-10 and 11A-14B.

Turning to FIG. 5, the lighting system 200, 201 can be unfolded from a closed position (e.g. closed position illustrated in FIGS. 11A-B), and the end caps 205 can be connected/mounted in a ceiling 300. The ceiling 300 can be formed by a support grid composed of longitudinal support beams 310 and transverse support beams 315. The longitudinal support beams 310 and transverse support beams 315 are arranged to form a grid pattern that is secured to the structural ceiling of the building and suspended below the structural ceiling. The end caps 205 can be configured to snap into position between two adjacent longitudinal support beams 315a and 315b. The end caps 205 can also be configured to releasably (snap) connect with a corresponding transverse support beam 310.

Turning to FIG. 6, ends 505 and 506 of the wing portions 210 can be configured to mate with and connect to ends 405 and 406 of the end cap 205, respectively. In an exemplary embodiment, a first end 506a of the first wing portion 210a can engage and connect with the ends 406 of the first end cap 205a and a second end 506b of the first wing portion 210a can engage and connect with the end 406 of the second end cap 205b. For example, the ends 506 of the first wing portion 210a can slidably engage with ends 506 of the end caps 205.

The lighting panel 215 is then brought into communication with the end caps 205. In an exemplary embodiment, the lighting panel 215 is rotated towards the top of the end caps 205 via the hinges 330 in the direction 525. FIG. 7A shows the lighting panel 215 connected to the end caps 205.

FIGS. 7B-7D illustrate exemplary embodiments and alternative views of the lighting system 200, 201 as shown in FIG. 7A. FIGS. 7A and 7B illustrate perspective views taken generally from the upper, front, right-hand side thereof. FIG. 7C illustrates a perspective view taken generally from the upper, back, left-hand side thereof. These views are taken from the area above the dropped ceiling 300. FIG. 7D illustrates a perspective view taken from below the lighting system 200, 201 (e.g., from the area that is illuminated by the lighting systems 200, 201).

As shown in FIGS. 7B and 7C, the lighting systems 200, 201 can include one or more power systems 605a, 605b. The power systems 605a, 605b can be disposed on the first wing portion 210a as shown. In other embodiments, the power systems 605a, 605b can be disposed on any combination of the lighting panel 215, the first wing portion 210a and second wing portion 210b. In an embodiment, the power systems 605a, 605b are located separate from the lighting systems 200, 201 and electrically (and/or communicatively) coupled to the lighting systems 200, 201.

The power systems 605a, 605b can include one or more circuits, processors, and/or logic. The power systems 605a, 605b can be configured to generate electrical power to power the lighting systems 200, 201, including converting (e.g., AC to DC), regulating, and/or adjusting, the electrical power supplied to the lighting systems 200, 201. The power systems 605a, 605b can be configured to filter, smooth, and/or otherwise adjust an input power to generate an output power that drives the lighting systems 200, 201. The power systems 605a, 605b can be configured to perform dimming operations to allow for the light emitted by the lighting systems 200, 201 to be dimmed.

The power systems 605a, 605b can include one or more controllers that are configured to control the operation of the lighting systems 200, 201. The controllers can control the brightness and/or color of the light generated by the lighting systems 200, 201. In an exemplary embodiment, the power systems 605a, 605b include one or more communication transceivers configured for wired and/or wireless communications to facilitate operation of the lighting systems 200, 201. For example, the transceiver(s) can be configured to communicate via Wi-Fi, Bluetooth, and/or Z-wave protocols, but is not limited to these example protocols.

With reference to FIGS. 7D and 7E, the lighting panel 215 of the lighting systems 200, 201 can include one or more locking mechanisms 345, 625 configured to releasably connect the lighting panel 215 to the end caps 205. The locking mechanism 345 is shown in more detail in the enlarged view 610 shown in FIG. 7E. The locking mechanism 625 is shown in more detail in the enlarged view 615 shown in FIG. 7F.

Turning to FIG. 7E, the lighting panel 215 is configured to engage and releasably connect to the end cap 205 via locking mechanism 345. The locking mechanism 345 can be a hook or other projection that engages with a corresponding receptacle of the end cap 205 to secure the lighting panel 215 to the end cap 205. For example, the locking mechanism 345 can be configured to rotate to engage/disengage the connection with the end cap 205. As shown in FIG. 4B, the lighting panel 215 can include one or more apertures 306 that are configured to accept a corresponding projection 307 of the end cap 205 to secure the lighting panel 215 to the end cap 205. In one or more embodiments, the wing portions 210 and lighting panel 215 are configured to snap together (e.g., a snap fit, a magnetic connection, etc.) with the end caps 205.

With continued reference to FIG. 7E, the coupler 335 and channel 342 are again illustrated. As discussed above, the second wing portion 210b is hingedly connected to the lighting panel 215 via the coupler 335. The connector 343 of the coupler 335 connects the coupler to the lighting panel 215 and is moveable within the channel 342 of the lighting panel 215. For example, the coupler 335 (axis of rotation 336 in FIG. 4B) is movable toward and away from the center of the lighting panel 215 (toward and away from the lighting sources 220) in the direction 337 (FIG. 4B) via the channel or track 342.

In an exemplary embodiment, the channel 342 can be L-shaped to allow the coupler 335 to travel toward and away from the center of the lighting panel 215 (direction 337) and toward and away from a top surface of the lighting panel 215. For example, the connector 343 of the coupler 335 can be connected to and moveable within the channel 342. When engaging the ends 505 of the second wing portion 210b with the ends 405 of the end cap 205, the connector 343 travels away from the center of the lighting panel 215 in the direction 337. Upon reaching the end of the channel 342 in the direction 337, the connector 343 can travel toward the lighting panel 215 in a direction orthogonal to the direction 337. Alternatively, upon reaching the end of the channel 342 in the direction 337, the connector 343 can travel toward the lighting panel 215 at an angle of other than 90 degrees to the direction 337.

In an exemplary embodiment, the end caps 205 can include one or more projections 307 that extend through corresponding apertures 306 of the lighting panel 215 to connect the lighting panel 215 to the end cap 205. The mating of the projections 307 and apertures 306 can be releasably locked via one or more locking mechanisms 625 as discussed below with reference to FIG. 7F.

As shown in FIG. 7F, the projection 307 can include one or more grooves or cutouts 607 that form a narrow portion of the projection 307 that is configured to connect with a corresponding latch or hook member 627 of the locking mechanism or member 625. The latch 627 can be configured to accept the narrow portion of the projection 307 when the locking mechanism 625 is brought into a locking contact with the projection 307. The locking mechanism 625 is configured to rotate about connection 626 that connects the locking mechanism 625 to the lighting panel 215. The locking mechanism 625 can rotate in the direction 631 towards the projection 307 to engage with and connect to the projection 307 (i.e., locking contact). The locking mechanism 625 can be rotated in the opposite direction to disconnect from the projection 307 (e.g., unlock). In an exemplary embodiment, the projection 307 can have a general T-shape where the locking mechanism 625 engages the vertical portion of the T-shaped projection below the horizontal portion of the T-shaped projection.

Now turning to FIGS. 8-9B, the second wing portion 210b is then connected to the end caps 205. As shown in FIG. 8, the second wing portion 210b is rotated upward, toward the end caps 205 via the coupler 335 in the direction 720 to engage the end caps 205. The second wing portion 210b is then moved away from the lighting panel 215 in the direction 810. In an exemplary embodiment, the second wing portion 210b is moved in the direction 810 after the second wing portion 210b is moved in the direction 720 and brought into contact with the end caps 205. In an alternative embodiment, the second wing portion 210b is moved in the direction 810 to engage the ends 505 of the second wing portion 210b with the ends 405 of the end caps 205 while moving and being brought into contact with the end caps 205. As the second wing portion 210b moves away from the lighting panel 215, the ends 505 of the second wing portion 210b engage and secures with a respective ends 405 of the end caps 205.

As shown in FIG. 9B, the channel 342 is L-shaped in an exemplary embodiment. The L-shaped channel 342 is configured to allow the connector 343 of the coupler 335 to travel along the channel 342 away from the center of the lighting panel 215 (e.g., towards the right relative to the drawing) and towards the top surface of the lighting panel 215 (e.g., upward direction relative to the drawing). For example, the connector 343 of the coupler 335 can be connected to and moveable within the channel 342. When the second wing portion 210b is moving in the direction 810 (FIG. 9A), the connector 343 moves along the channel 342 (horizontal portion relative to the drawing). As the ends 505 of the wing portion 210b engage the ends 405 of the end caps 205, the connector 343 travels in the portion (e.g., vertical portion relative to the drawings) of the channel 342 and toward the surface of the lighting panel 210. For example, upon reaching the end of the channel 342 in the horizontal direction, the connector 343 travels upward (vertical).

In an exemplary embodiment, the coupler 335 can be configured to slidably engage a locking mechanism 815 of a respective end cap 205 as the second wing portion 210b and coupler 335 are moved through the channel 342 due to the second wing portion 210b moving in the direction 810.

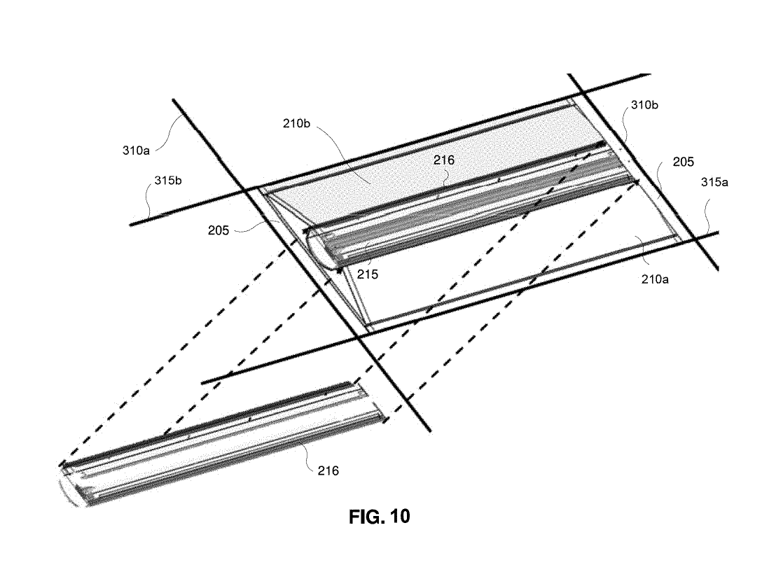

Turning to FIG. 10, the lens 216 can be connected with the lighting panel 215. The connection can be a releasable connection such as a snapped connection.

FIGS. 11A-14B illustrate the lighting system 200, 201 in closed configurations according to exemplary embodiments of the present disclosure. The systems 200, 201 can be stored and transported in these closed/folded configurations to reduce the overall size of the systems 200, 201 while also simplifying installation by limiting and/or reducing the need for tooled assembly and the number of independent parts of the systems 200, 201.

FIGS. 11A-11B show the wing portions 210 folded backwards upon the lighting panel 215 to form a compartment that can house, for example, the end caps 205 and one or more lenses (e.g., 217). Because the wing portions 210 are folded backwards upon the lighting panel 215, the lighting panel 215 and the light source(s) 220 face the outside of the folded system.

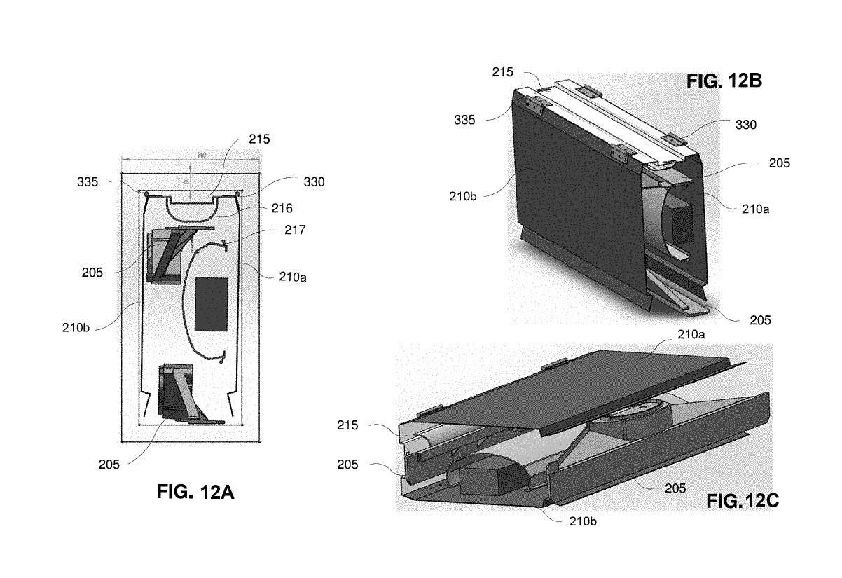

FIGS. 12A-12C show the wing portions 210 folded frontward over the lighting panel 215 to form a compartment that can house, for example, the end caps 205 and one or more lenses (e.g., 217). Because the wing portions 210 are folded frontward over the lighting panel 215, the lighting panel 215 and the light source(s) 220 face the inside of the folded system.

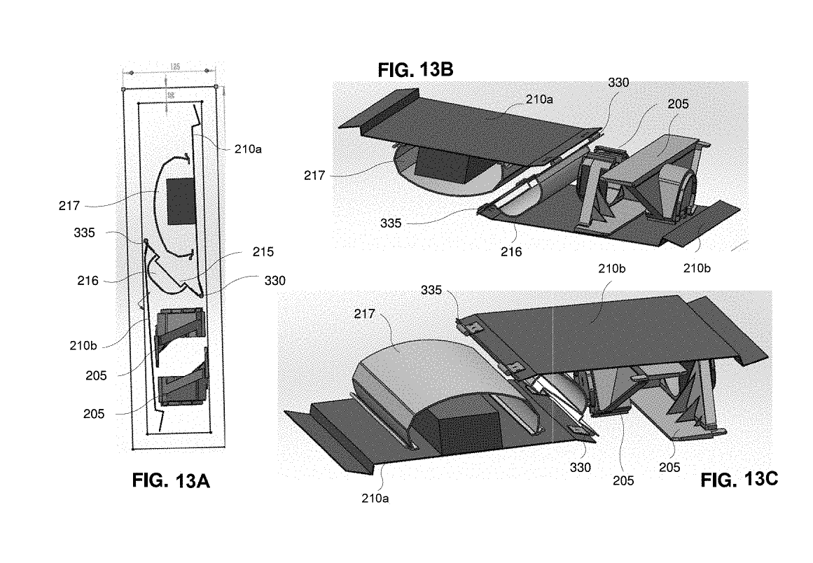

FIGS. 13A-13C show the first wing portion 210a folded over the back of the lighting panel 215 and the second wing portion 210b is folded over the front of the lighting panel 215. In an exemplary embodiment, the folded configuration is Z-shaped. The end caps 205 are arranged adjacent to the second wing portion 210b and the one or more lenses (e.g., 217) are arranged adjacent to the first wing portion 210a.

FIGS. 14A-14B show the wing portions 210 folded frontward over the lighting panel 215 to form a compartment that can house, for example, the end caps 205 and one or more lenses (e.g., 217). Because the wing portions 210 are folded frontward over the lighting panel 215, the lighting panel 215 and the light source(s) 220 face the inside of the folded system.

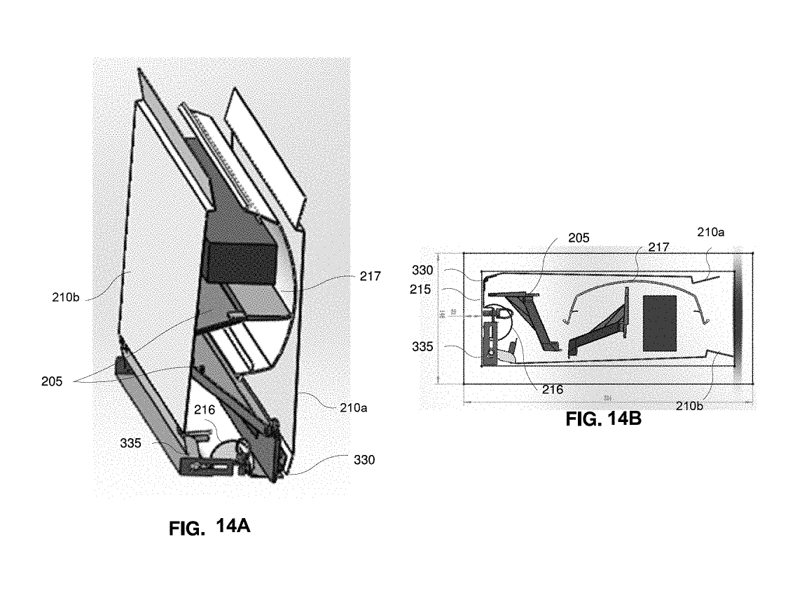

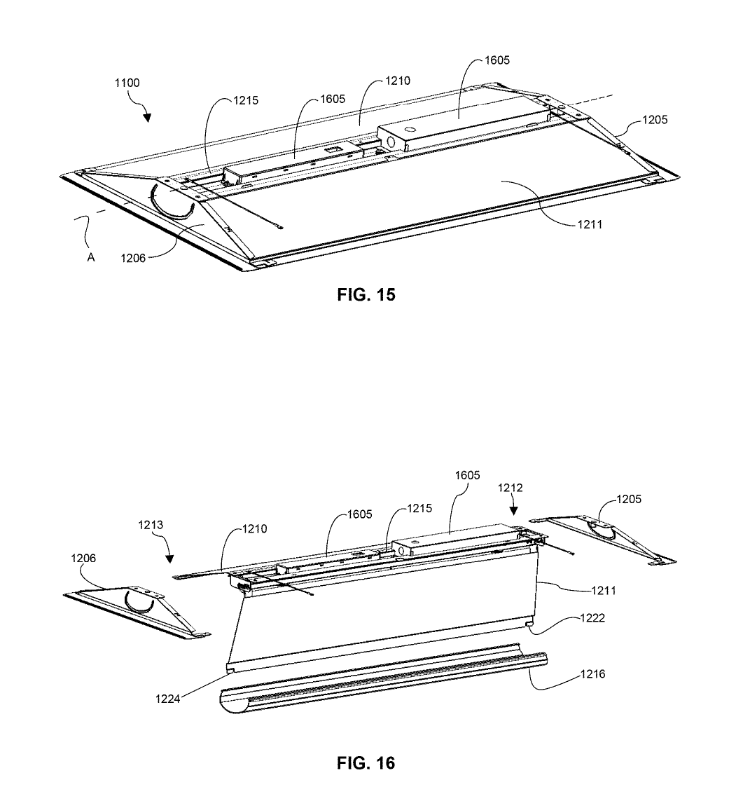

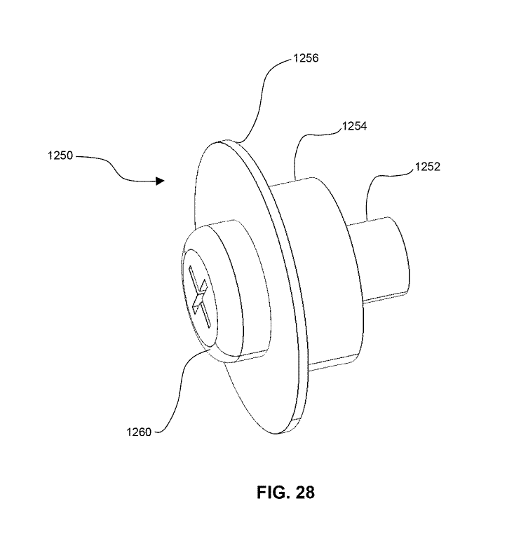

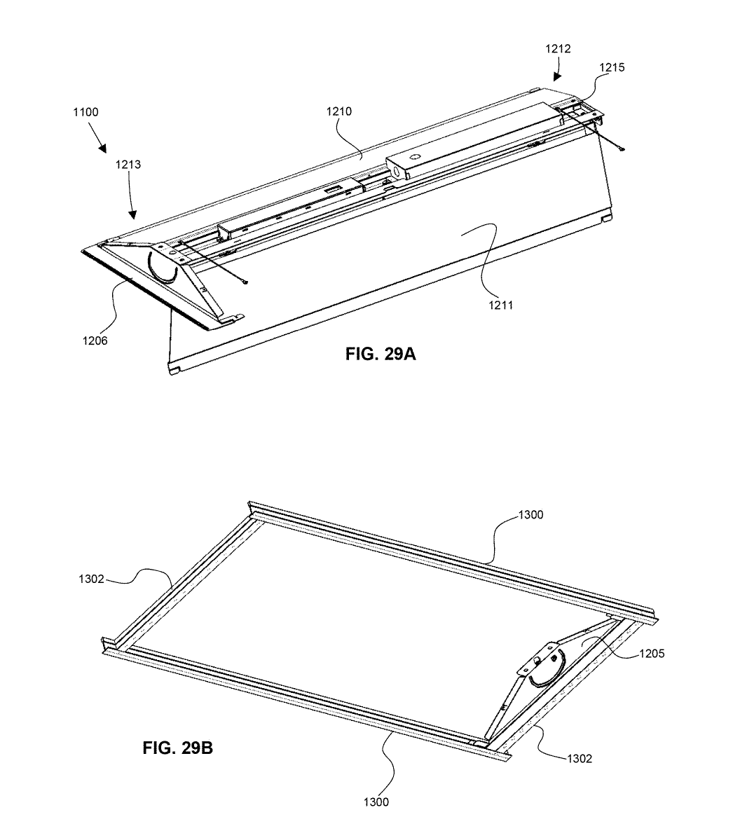

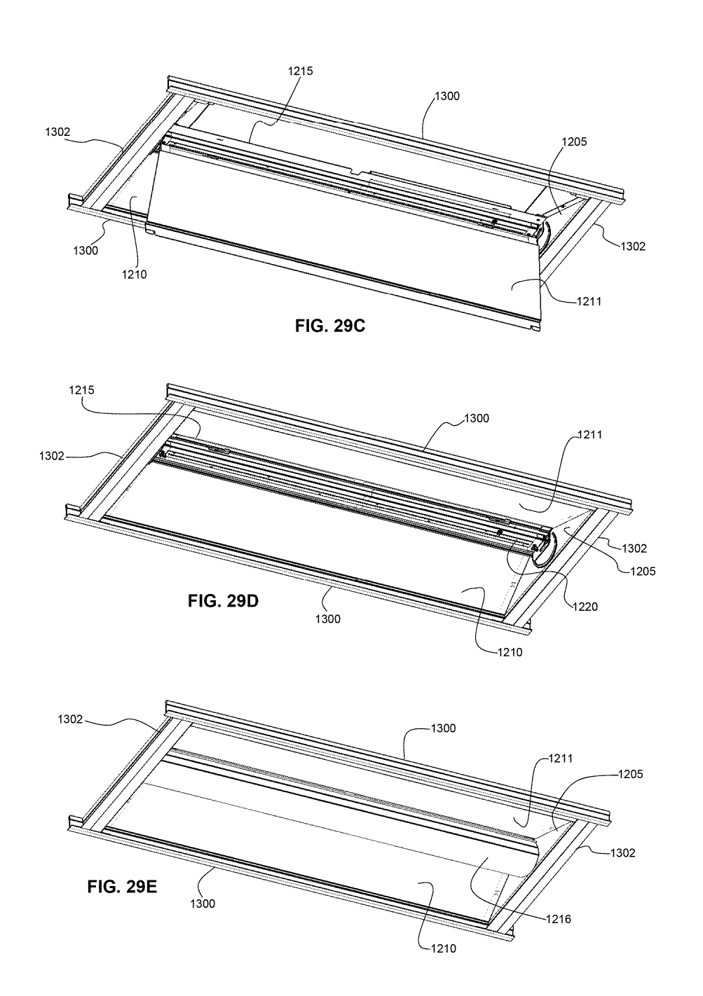

In another embodiment, shown in FIGS. 15-29E, a troffer lighting system 1100 includes a lighting panel 1215 having one or more light sources 1220 (shown in FIG. 29D), a first wing portion 1210 fixedly coupled to the lighting panel 1215, and a second wing portion 1211 hingedly coupled to the lighting panel 1215. The second wing portion 1211 is configured to be movable between a closed position, as shown in FIG. 16, to an open position, as shown in FIG. 15. As described above, this allows the lighting system 1100 to be packaged efficiently while also providing easy installation with little assembly at the time of installation. The lighting panel 1215 can include one or power systems 1605, as described above. The lighting system 1100 can also include a lens 1216 configured to cover the light sources 1220.

In one embodiment, the lighting system 1100 also includes a first end cap 1205 and a second end cap 1206. The first end cap 1205 is configured to engage with a first end 1212 of the lighting panel 1215 and the first 1210 and second 1211 wing portions. The second end cap 1206 is configured to engage with a second end 1213 of the lighting panel 1215 and the first 1210 and second 1211 wing portions. In at least one embodiment, the first end cap 1205 and the second end cap 1206 are the same component or component mirror to each other. In other embodiments, the first end cap 1205 and the second end cap 1206 are different components.

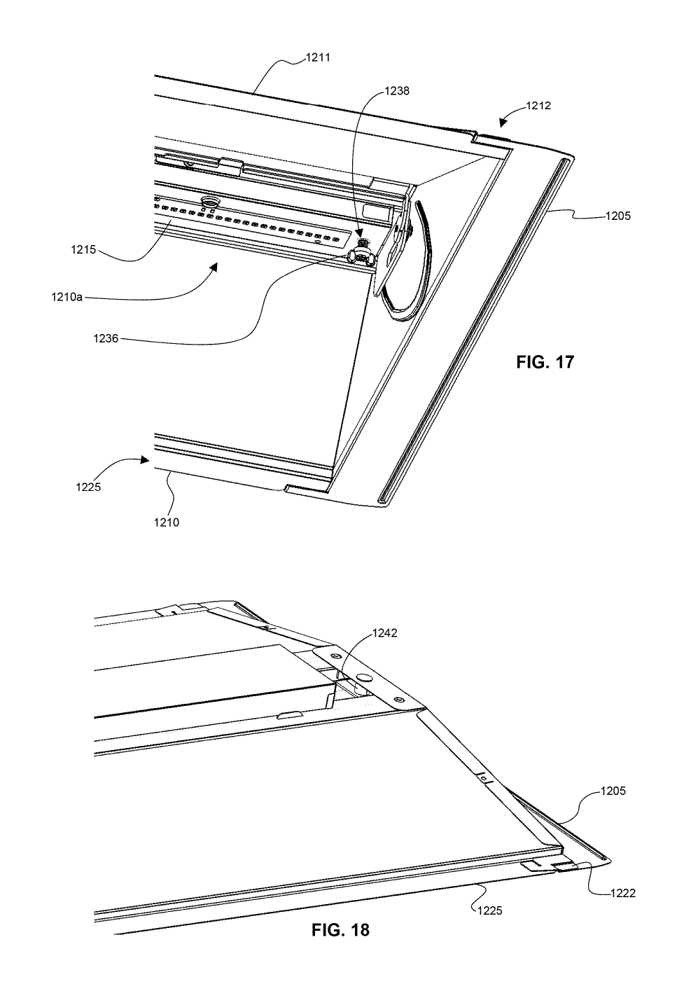

The first end cap 1205 and the second 1206 end cap can couple to the lighting panel 1215 and first 1210 and second 1211 wing portions in any appropriate manner. For example, in one embodiment, as shown in FIGS. 17 and 18, the first wing portion 1210 includes a medial portion 1210a adjacent to the lighting panel 1215, and a lateral portion 1225 opposite to the medial portion 1210a. At the first end 1212, the lateral portion 1225 of the first wing portion 1210 is configured to interlock with the first end cap 1205. Further, at the second end 1213, the lateral portion 1225 of the first wing portion 1210 is configured to interlock with the second end cap 1206. The second wing portion 1211 is configured to similarly interlock with the first end cap 1205 and the second end cap 1206.

In one embodiment, the second wing portion 1211 includes a first locking tab 1222 at the first end 1212 of the lateral portion 1225 and a second locking tab 1224 at the second end 1213 of the lateral portion 1225. Referring to FIG. 21, the locking tabs 1222, 1224 can be raised relative to the lateral portion 1225. The first end cap 1205 includes a slot 1226 (FIG. 22) configured to receive the first locking tab 1222 and the second end cap 1206 includes a slot 1228 configured to receive the second locking tab 1224. As shown in FIG. 22, the slot 1226 can be formed in an extension 1230 of the first end cap 1205. The extension 1230 is configured to extend substantially parallel to a longitudinal axis A (shown in FIG. 15) extending between the first end 1212 and the second end 1213. The slot 1226 is formed between an upper portion 1232 and a lower portion 1234 of the extension 1230. As such, when engaged, a portion of the locking tab 1222 is below the upper portion 1232 and a portion of the locking tab 1222 is above the lower portion 1234. Additionally, a portion of the extension 1230 can extend above the lateral portion 1225. As a result, when the first locking tab 1222 is inserted through the slot 1226, a secure connection is formed between the first wing portion 1210 and the first end cap 1205. Similar connections are formed at each of the four corners of the lighting system 1100, thereby providing structural integrity.

In other embodiments, the configuration of the locking tab and the slot is reversed. In other words, the first end cap 1205 includes a locking tab configured to engage a slot in the first wing portion.

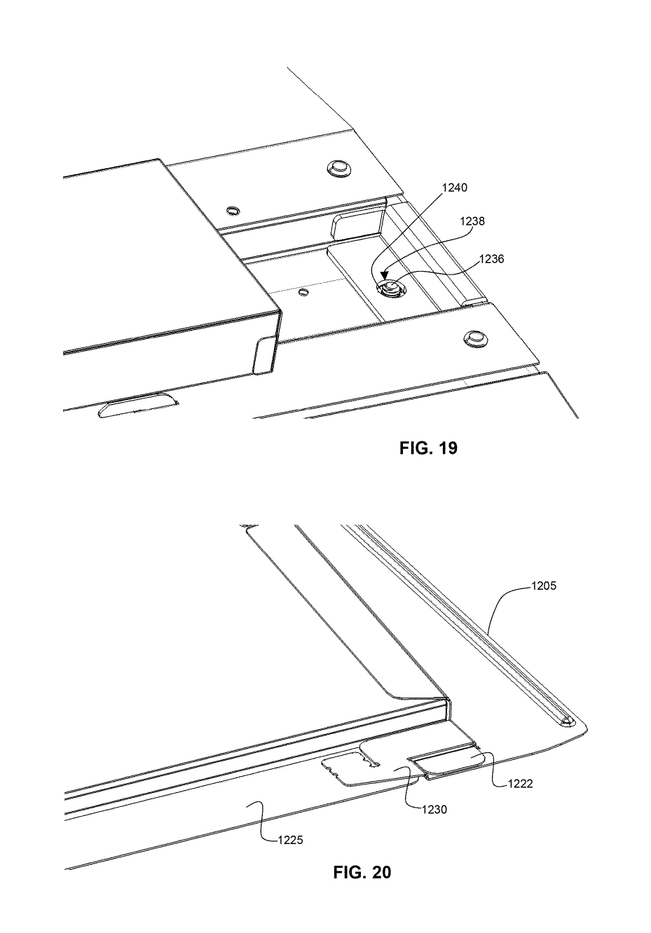

In addition, as shown in FIG. 17, the troffer lighting system 1100 can also include a locking screw 1236 configured to couple the lighting panel 1215 and the first end cap 1205. The locking screw 1236 can be initially coupled to the first end 1212 of the lighting panel 1215 and disposed in a hole 1238. The locking screw 1236 can be retained by a clip 1240 (shown in FIG. 19) on the upper side of the lighting panel 1215. The first end cap 1205 can include a stud 1242 (shown in FIG. 18) configured to receive the locking screw 1236. The stud 1242 can include internal threads complimentary to the locking screw 1236. The second end cap 1206 and the second end 1213 of the lighting panel 1215 can be coupled in a similar way.

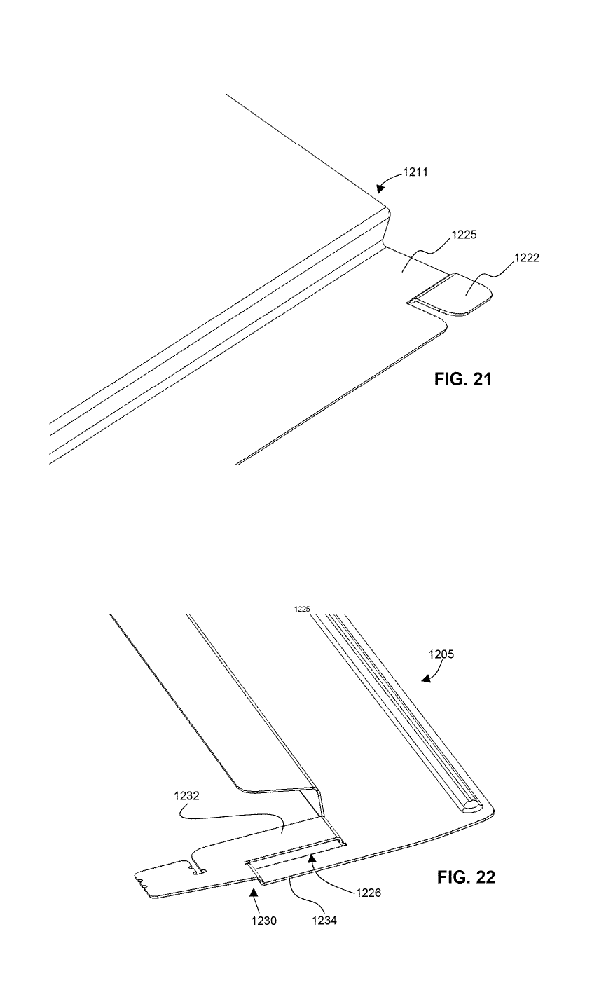

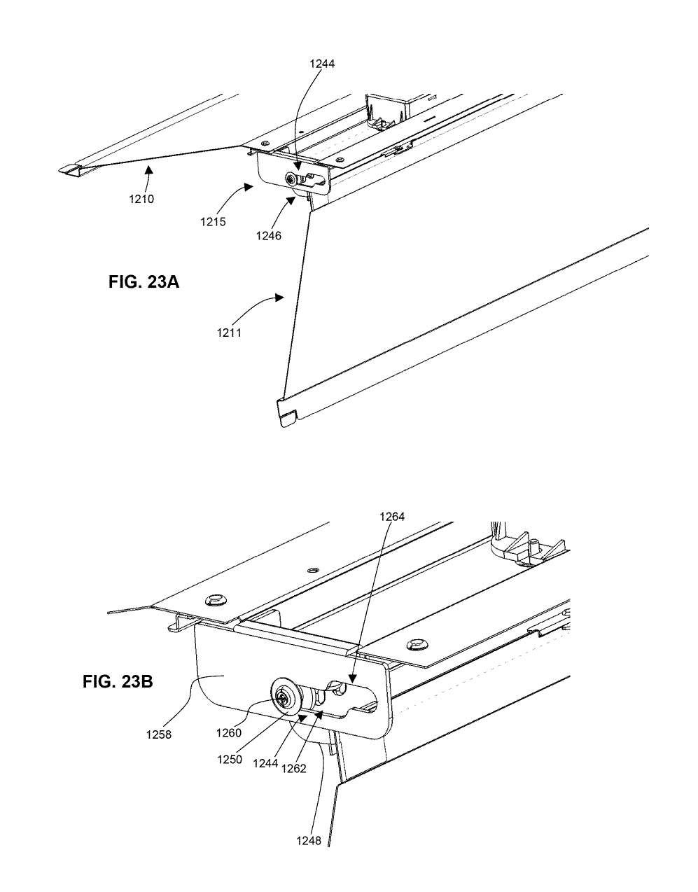

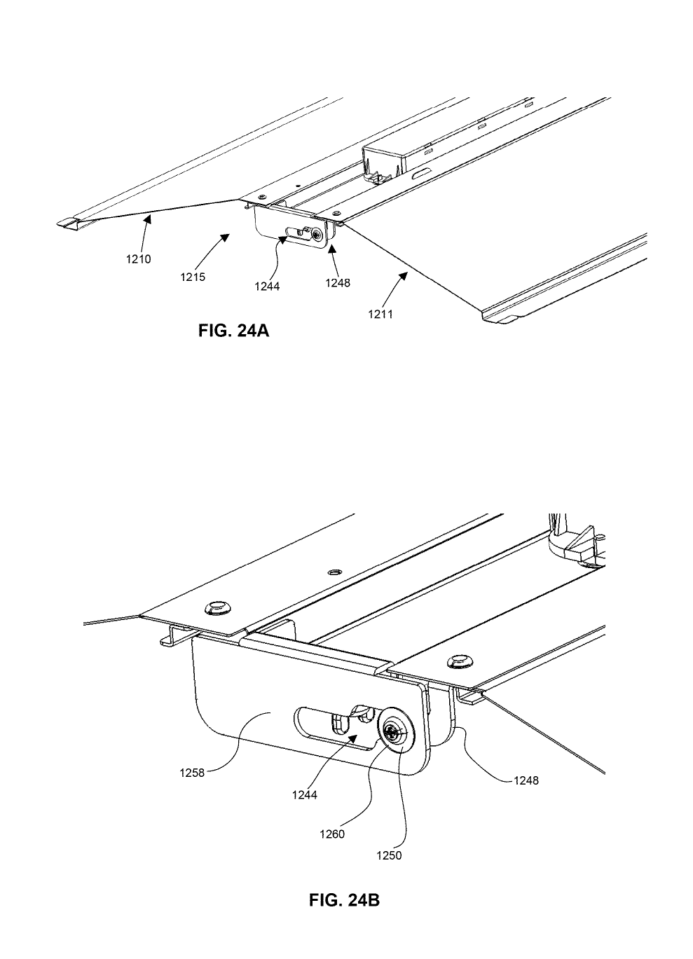

As shown in FIGS. 23A-24B, the lighting panel 1215 includes a channel 1244 and the second wing portion 1211 includes a connector 1250 coupled to the channel 1244 and be translatable therein. A coupler 1248 couples the second wing portion 1211 to the connector 1250. In one embodiment, shown in FIG. 28, the connector 1250 includes a threaded rod 1252 configured to engage the coupler 1248, a shoulder 1254 configured to ride within channel 1244, a washer 1256 configured to be adjacent to a face 1258 opposite to the coupler 1248, and a head 1260. The head 1260 can be configured to interface with a tool to allow the connector 1250 to be tightened, loosened, or removed. The connector 1250 can be formed of a unitary body or, alternatively, can be separate components assembled together.

The connector 1250 and coupler 1248 allow the second wing portion 1211 to rotate with respect to the lighting panel 1215. In addition, in at least one embodiment, the connector 1250 is translatable within the channel 1244. As a result, in addition to rotation, the second wing portion 1211 may translate laterally away from the lighting panel 1215 as it moves from the closed position to the open position.

As shown in FIGS. 23A-23B, in one embodiment, the channel 1244 includes a first leg 1262 connected to a second leg 1264 by a transition portion 1266. The first leg 1262 is below the second leg 1264. When in the closed position, the connector 1250 is disposed in the first leg 1262, as shown in FIGS. 23A and 23B. It should be noted that the second wing portion 1211 may rotate toward the first wing portion 1210 more than is shown in FIG. 23A. In one embodiment, the second wing portion 1211 rotates until it is in contact with, or adjacent to, the first wing portion 1210. When in the open position, the connector 1250 is disposed in the second leg 1264, as shown in FIGS. 24A and 24B. As a result, as the second wing portion 1211 moves from the closed position to the open position, the connector 1250, and second wing portion 1211, travels upward relative to the lighting panel 1215. This allows the second wing portion 1211 to be in the proper position when installed in a ceiling. In one embodiment, the first leg 1262 and the second leg 1264 are parallel.

The lighting system 1100 can include the same type of channel, coupler, and connector arrangement at the second end 1213. Alternatively, a different type of coupler and connector may be used at the second end 1213.

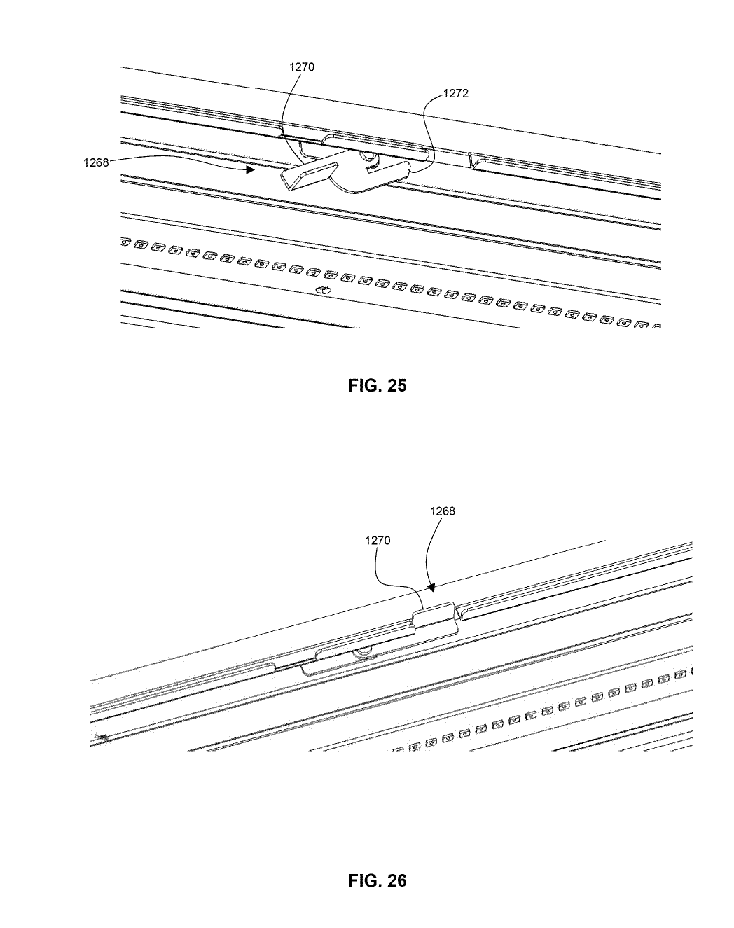

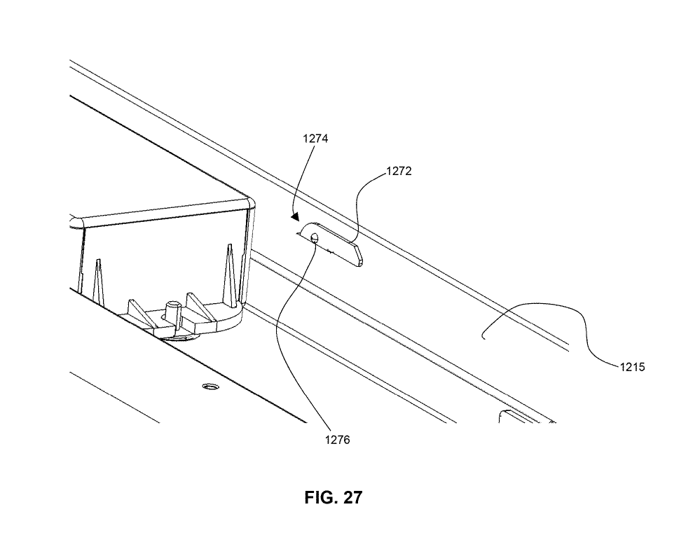

As shown in FIGS. 25-27, the lighting system 1100 also includes a locking mechanism 1268. When the locking mechanism 1268 is in a first configuration, as shown in FIG. 25, the second wing portion 1211 is able to rotate with respect to the lighting panel 1215. When the locking mechanism 1268 is in a second configuration, as shown in FIG. 26, the second wing portion 1211 is prevented from rotating with respect to the lighting panel 1215. The locking mechanism 1268 can include a lock 1270 rotatably coupled to the second wing portion 1211. The lock 1270 includes an arm 1272 that is configured to engage the lighting panel 1215 to prevent relative rotation of the second wing portion 1211. The lighting panel 1215 includes an aperture 1274 through which the arm 1272 passes. As shown in FIG. 27, when the locking mechanism 1268 is in the second configuration, the arm 1272 is disposed on the top side of the lighting panel 1215 to prevent rotation of the second wing portion 1211. The arm 1272 can include a thickened portion 1276 that has a thickness greater than a width of the aperture 1274. As a result, the lock 1270 is maintained in the second, or locked, configuration. The thickened portion 1276 can be an integrally formed portion of the arm 1272. Alternatively, a pin or other secondary component can be coupled to the arm 1272 to form the thickened portion 1276.

In another embodiment, shown in FIGS. 29A-29E, a method of installing the troffer lighting system 1100 in a drop ceiling is provided. As shown in FIG. 29A, the method includes connecting the second end cap 1206 to the second end 1213 of the lighting panel 1215 and the first wing portion 1210. As shown in FIG. 29B, the method also includes mounting the first end cap 1205 into the drop ceiling and connecting the second end 1213 of the lighting panel 1215 and the first wing portion 1210 to the second end cap 1206, as shown in FIG. 29C. The method also includes rotating the second wing portion 1211 from the closed position to the open position in which it is engaged with the first end cap 1205 and the second end cap 1206 (FIG. 29D). As shown in FIG. 29E, the method also includes connecting a lens 1216 to the lighting system 1100.

The lighting system can be mounted to a grid in the ceiling having longitudinal support beams 1300 and transverse support beams 1302.

The method may also include connecting the first end cap 1205 to the first end 1212 of the lighting panel 1215 by coupling the lighting panel 1215 to the first end cap 1205 with a first locking screw 1236. Further, connecting the second end cap 1206 to the second end 1213 of the lighting panel 1215 can include coupling the lighting panel 1215 to the second end cap 1206 with a second locking screw 1236.

The method can also include interlocking lateral portions of the wing portions 1210, 1211 with the first 1205 and second 1206 end caps.

The method can also include moving a locking mechanism 1268 from a first configuration to a second configuration in which the locking mechanism 1268 prevents rotation of the second wing portion 1211 with respect to the lighting panel 1215.

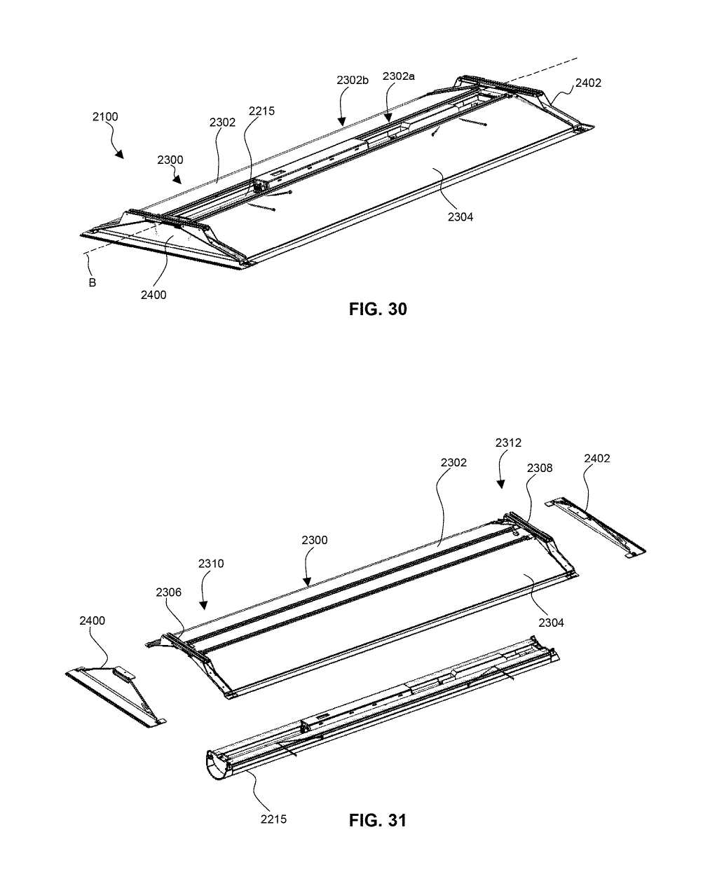

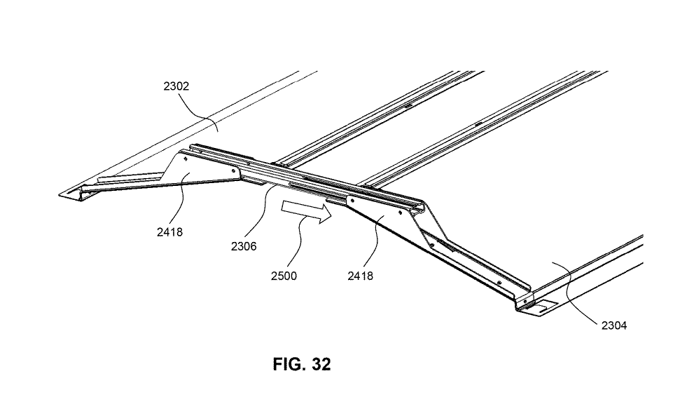

In another embodiment, as shown in FIGS. 30-48, a troffer lighting system 2100 includes a lighting module 2215 and a reflector assembly 2300. The reflector assembly 2300 includes a first reflector 2302, a second reflector 2304, a first rail 2306 coupled to a first end 2310 of the reflectors 2302, 2304, and a second rail 2308 coupled to a second end 2312 of the reflectors 2302, 2304. The second end 2312 is opposite to the first end 2310, and a longitudinal axis B is defined between the first end 2310 and the second end 2312. At least one of the first reflector 2302 and the second reflector 2304 are movable from a collapsed configuration to an extended configuration. For example, in one embodiment, the second reflector 2304 is axially translatable in a direction 2500 (shown in FIG. 32) orthogonal to the longitudinal axis B. The lighting module 2215 is configured to removably couple to the reflector assembly 2300.

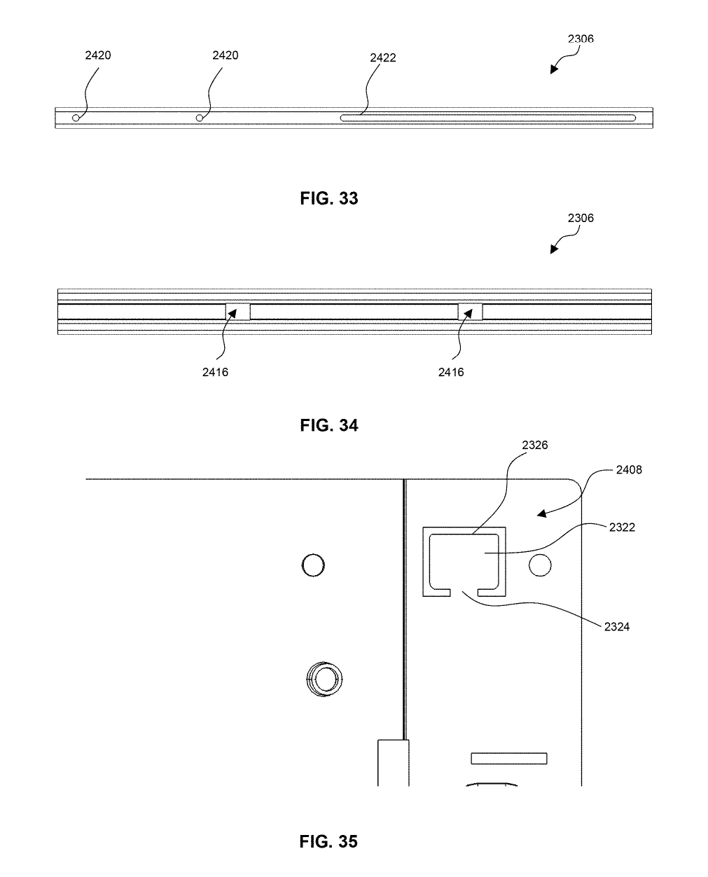

Each of the reflectors 2302, 2304 can be connected to the first and second rails 2306, 2308 via brackets 2418. As shown in FIG. 33, on one end of the rails 2306, 2308 mounting holes 2420 may allow the first reflector 2302 to be fixedly coupled to the rail. The opposite end of the rail includes a slot 2422 that allows the second reflector 2304 to be mounted such that the bracket can translate relative to the rail. In other embodiments, each end of the rail includes a slot, allowing both the first 2302 and second 2304 reflectors to translate with respect to the rail.

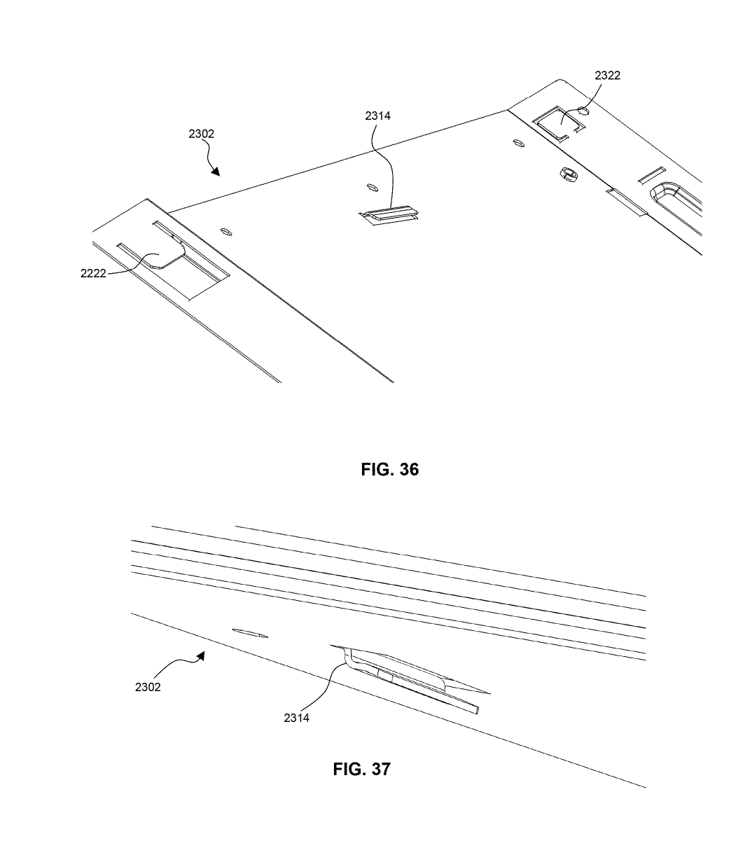

In at least one embodiment, the troffer lighting system 2100 further includes a first end cap 2400 and a second end cap 2402. The first end cap 2400 is configured to engage with the first end 2310 of the reflector assembly 2300. The second end cap 2402 is configured to engage with the second end 2312 of the reflector assembly 2300. In at least one embodiment, as shown in FIGS. 36-38, the first reflector 2302 includes a hook 2314 extending from a bottom surface of the first reflector 2302 and configured to engage the first end cap 2400 such that the first end cap 2400 is securely engaged with the first reflector 2302. Similarly, the first reflector 2302 can include a second hook to securely engage the second end cap 2402. The second reflector 2304 can also include first and second hooks to engage the first 2400 and second 2402 end caps, respectively.

In addition, each of the reflectors 2302, 2304 includes a medial portion (e.g., 2302a shown in FIG. 30) adjacent to the center of the lighting system 2100, and a lateral portion (e.g., 2302b, shown in FIG. 30) opposite to the medial portion 2302a. The first end 2310 of the lateral portion 2302b of the first reflector 2302 is configured to interlock with the first end cap 2400, and the second end 2312 of the lateral portion 2302b is configured to interlock with the second end cap 2402. This interlocking can be substantially similar to that described above with respect to the lighting system 1100. Similarly, the second reflector 2304 can also interlock with the first 2400 and second 2402 end caps. As described above, this increases the structural integrity of the lighting system 2100.

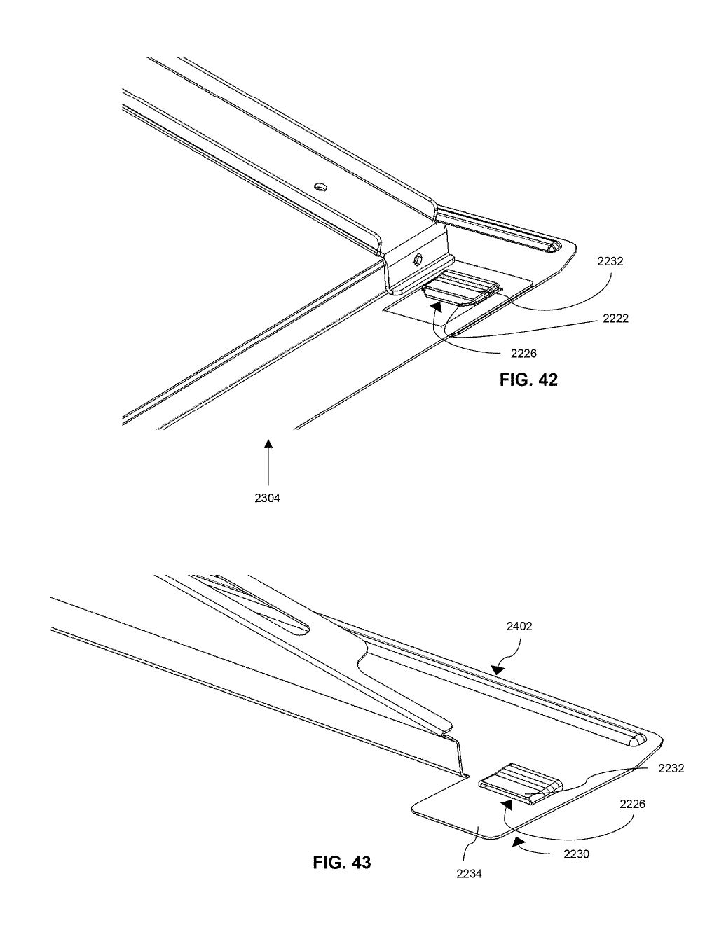

Alternatively, as shown in FIGS. 42-44, the second reflector 2304 can have a locking tab 2222 extending longitudinally (i.e., parallel to the longitudinal axis B). The locking tab 2222 is configured to engage slot 2226 formed between upper portion 2232 and lower portion 2234 of extension 2230 of second end cap 2402, as shown in FIG. 43. As a result, as will be described further herein, during installation, the second end cap 2402 can be slid axially along the reflector assembly 2300 until the locking tabs engage the slots.

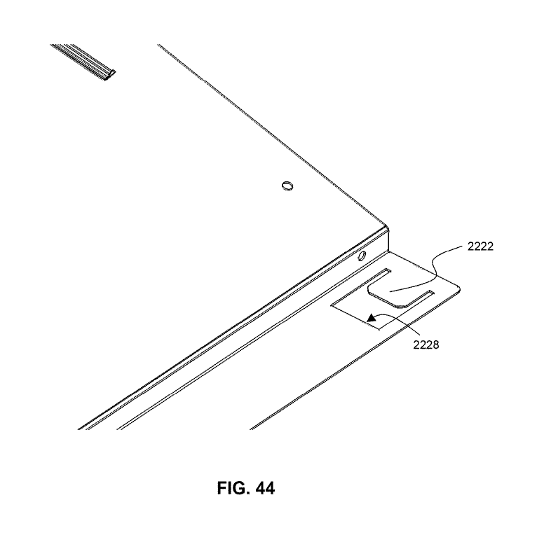

As shown in FIG. 44, the reflectors 2302, 2304 define a window 2228 through which the upper portion 2232 of the extension 2230 can pass during installation of the end cap 2402. Hence, as the end cap 2402 is installed, the end cap is moved upward such that the upper portion 2232 passes through window 2228, and then the end cap 2402 is slid toward the end of the reflector such that locking tab 2222 engages slot 2226.

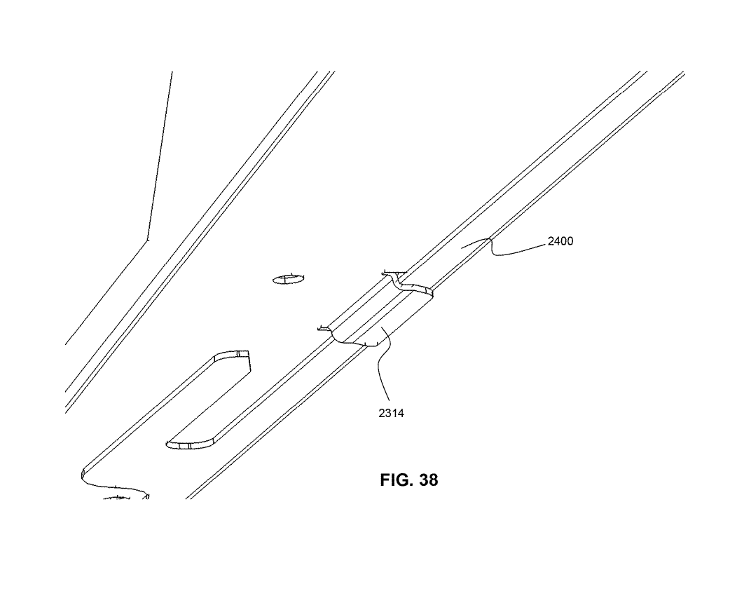

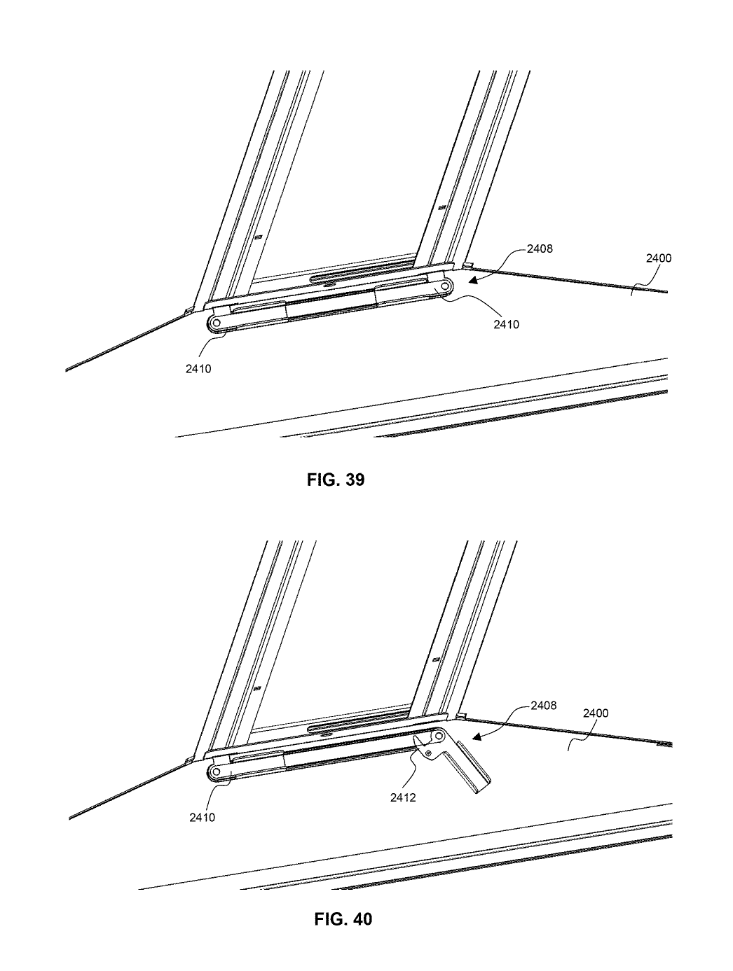

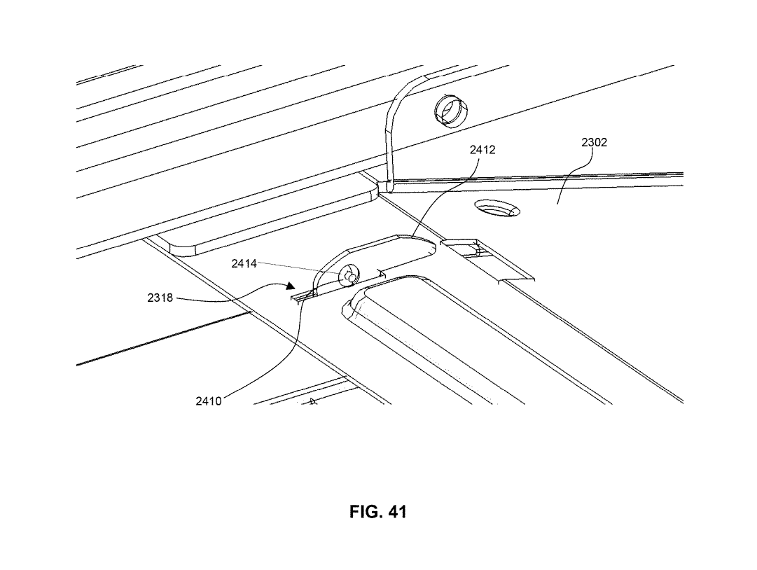

As shown best in FIGS. 39-41, the troffer lighting system 2100 can also include a locking mechanism 2408 to secure the first end cap 2400 to the one or both of the reflectors 2302, 2304. The locking mechanism 2408 includes a lock 2410 rotatably coupled to the first end cap 2400 and configured to rotate from an unlocked position, shown in FIG. 40, to a locked position, shown in FIG. 39. As shown in FIG. 41, an arm 2412 of the lock 2410 is configured to pass through an opening 2318 of the first reflector 2302 and engage an upper side of the first reflector 2302. The opening 2318 has a width measured parallel to the longitudinal axis B and the lock 2410 is rotatable about an axis that is also parallel to the longitudinal axis B. The lock 2410 also includes thickened portion 2414 that has a thickness parallel to the longitudinal axis that is greater than the width of the opening 2318. The thickened portion 2414 is configured to pass through the opening 2318 and be disposed above the first reflector 2302 when the first end cap 2400 is engaged with the first reflector 2302 and the lock 2410 is in the locked position. As a result, the lock 2410 is securely held in the locked position. The thickened portion 2414 can be an integrally formed portion of the lock 2410. Alternatively, a pin or other component can be coupled to the lock 2410 to form the thickened portion 2414.

In at least one embodiment, a second lock 2410 is provided to secure the first end cap 2400 to the second reflector 2304. The second lock 2410 can be, in at least one embodiment, substantially similar to the first lock 2410. Further, the second end cap 2402 can also include one or more locks to couple the second end cap 2402 to the first reflector 2302 and/or the second reflector 2304.

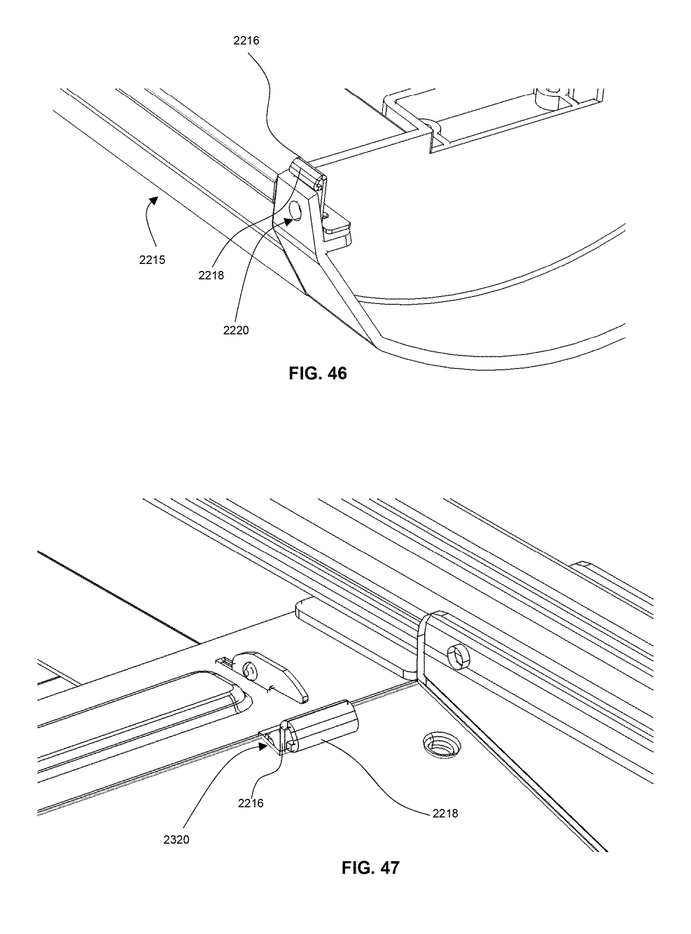

The lighting module 2215 can be attached to the reflector assembly 2300 in any appropriate manner. For example, as shown in FIGS. 46-47, in one embodiment, the lighting module 2215 includes arms 2216 configured to pass through windows 2320 defined by the reflectors 2302, 2304. The arms 2216 include a flange 2218 that is configured to be disposed above the respective reflector 2302, 2304 to securely retain the lighting module 2215 in place. In addition, the lighting module 2215 includes apertures 2220 aligned with a portion of the arms 2216. Hence, to remove the lighting module 2215 from the reflector assembly 2300, a tool (e.g., a screwdriver) can be inserted through the aperture 2220 to deflect the arm 2412 and disengage it from the reflector. This allows for easy removal of the lighting module 2215 for maintenance, replacement, or other purposes.

As shown in FIG. 35, the first and second reflectors 2302, 2304 also include a locking mechanism 2408 configured to lock the respective reflector in the extended configuration. The locking mechanism 2408 includes a cantilever tab 2322 having a first, connected end 2324 and a second, free end 2326. The second end 2312 is configured to engage either the first 2306 or the second 2308 rail when the reflector 2302, 2304 is in the extended configuration. For example, the cantilever tab 2322 can be bent upward into window 2416 (shown in FIG. 34) of the first 2306 or second 2308 rail. When bent upward in such a manner, the cantilever tab 2322 prevents movement of the reflector. In at least one embodiment, there is a cantilever tab 2322 at the first end 2310 and the second end 2312 of each of the reflectors 2302, 2304.

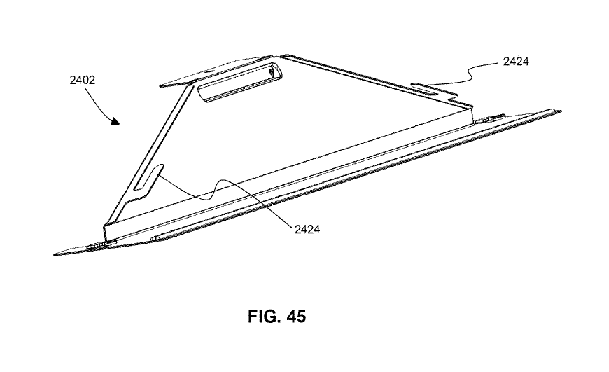

As shown in FIG. 45, the first 2400 or second 2402 end cap can include one or more hooks 2424 configured for easy handling and storage. The hooks 2424 can extend from a back side of the end cap and be angled upward.

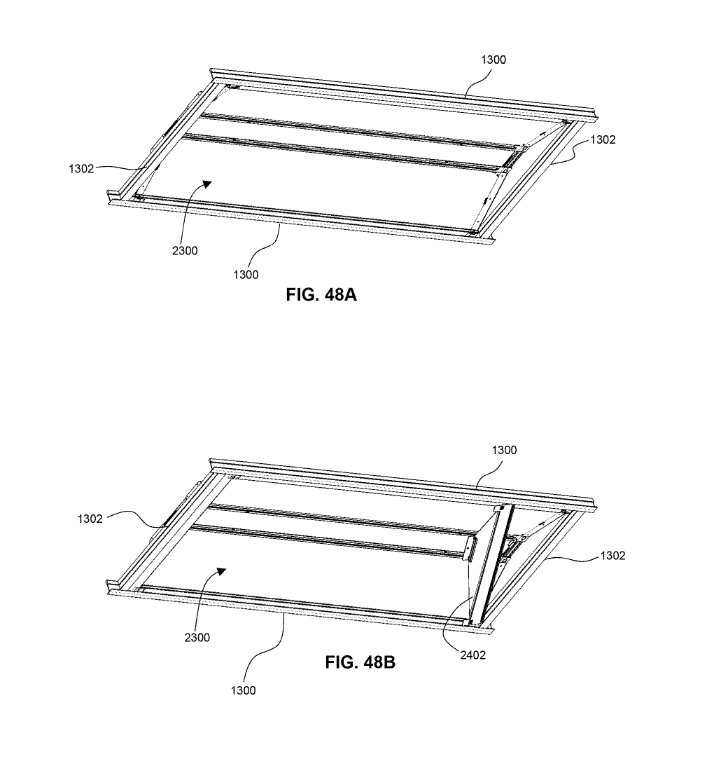

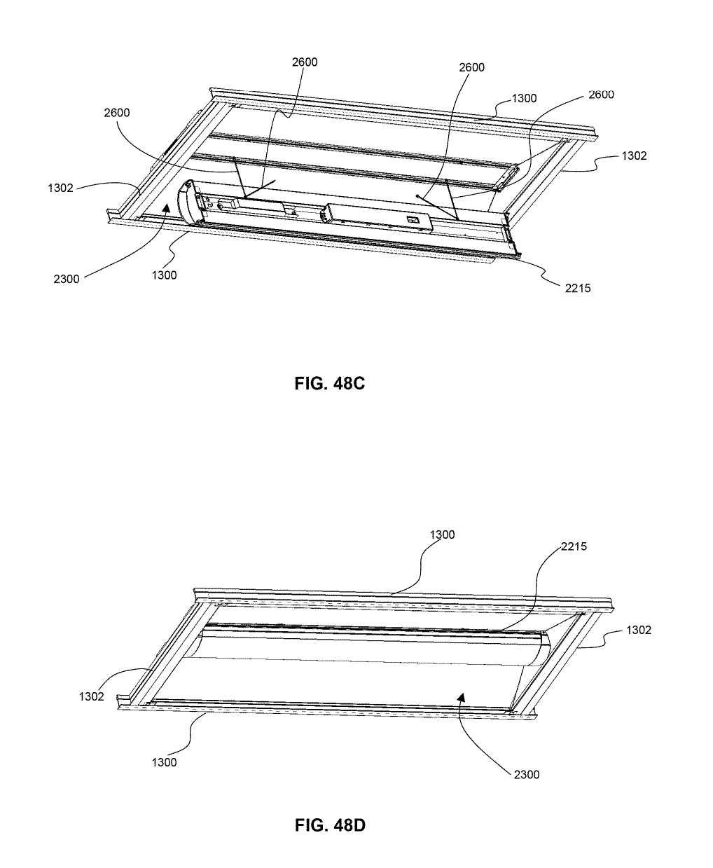

In another embodiment, shown in FIGS. 48A-48B, a method of installing the troffer lighting system 2100 is provided. As shown in FIG. 48A, the method includes installing the reflector assembly 2300 in a drop ceiling. The reflector assembly includes the first reflector 2302, the second reflector 2304, the first rail 2306 coupled to the first end 2310 of the reflectors 2302, 2304, and the second rail 2308 coupled to the second end of the reflectors 2302, 2304. The second end 2312 is opposite to the first end 2310 and a longitudinal axis is defined between the first end 2310 and the second end 2312. The method also includes translating the second reflector 2304 from a collapsed configuration to an extended configuration. The second reflector 2304 is axially translatable in a direction orthogonal to the longitudinal axis. As shown in FIG. 48B, the method further includes connecting the first end cap 2400 to the first end 2310 of the reflector assembly 2300. The method also includes connecting a second end cap 2402 to the second end 2312 of the reflector assembly 2300. As shown in FIG. 48D, the method also includes connecting the lighting module 2215 to the reflector assembly 2300.

In one embodiment, the method also includes locking the first reflector 2302 in the extended configuration by inserting a cantilever tab 2322 of the first reflector 2302 into the first rail 2306.

In one embodiment, the step of connecting the first end cap 2400 to the first end 2310 of the reflector assembly 2300 includes rotating a lock 2410 about an axis parallel to the longitudinal axis such that a portion of the lock 2410 passes through an opening 2318 of the first reflector 2302 such that an arm 2412 of the lock 2410 is disposed above the first reflector 2302.

In one embodiment, the step of connecting the first end cap 2400 to the first end 2310 of the reflector assembly 2300 further includes interlocking a lateral portion 2302b of the first reflector 2302 with the first end cap 2400.

In one embodiment, the step of connecting the first end cap 2400 to the first end 2310 of the reflector assembly 2300 includes engaging a first slot 2404 of the first end cap 2400 with a first locking tab 2316 of the first reflector 2302 and engaging a second slot 2404 of the first end cap 2400 with a first locking tab 2316 of the second reflector 2304.

In one embodiment, the step of connecting the second end cap 2402 to the second end 2312 of the reflector assembly 2300 includes engaging a first slot 2404 of the second end cap 2402 with a second locking tab 2316 of the first reflector 2302 and engaging a second slot 2404 of the second end cap 2402 with a second locking tab 2316 of the second reflector 2304.

In one embodiment, the step of connecting the lighting module 2215 to the reflector assembly 2300 includes passing an arm 2412 of the lighting module 2215 through a window 2320 of the reflector assembly 2300 such that a portion of the arm 2412 engages a top surface of the reflector assembly 2300.

As illustrated in FIG. 48C, in one embodiment, the method further includes connecting one or more safety straps 2500 between the lighting module 2215 and the reflector assembly 2300. This allows the lighting module 2215 to hang from the reflector assembly 2300. With the lighting module 2215 hanging, the lighting module 2215 can easily be connected to the building's electrical and other systems. The safety straps 2500 can extend from the lighting module 2215 to one or more hooks or other connectors on the reflector assembly 2300 to securely retain the lighting module 2215. In one embodiment, the lighting module 2215 can be hung from either side of the reflector assembly 2300. This allows the lighting module 2215 to be easily accessed from either side to allow installation and maintenance to be performed.

All the similar or identical items share the common features such as shapes, materials as described. For brevity, the descriptions are not repeated. For example, the shape and dimension of the lighting system in each embodiment may be the same as the lighting system 100 or 101 as described. The wing portions or reflectors in each embodiment may have the same shape and be made of the same materials as for the wing portion 210 as described. The lighting panel and the lighting sources in each embodiment may be the same as the lighting panel 215 and lighting source 220 as described.

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

What is claimed is:

1. A troffer lighting system, comprising:
a lighting panel having one or more light sources;
a first wing portion fixedly coupled to the lighting panel; and
a second wing portion hingedly coupled to the lighting panel, wherein the second wing portion is movable between a closed position and an open position.

2. The troffer lighting system of claim 1, further comprising first and second end caps, the first end cap being configured to engage with a first end of the lighting panel and a first end of the first and second wing portions, and the second end cap being configured to engage with a second end of the lighting panel and a second end of the first and the second wing portions, wherein the first end of the lighting panel is opposite to the second end of the lighting panel.

3. The troffer lighting system of claim 2, wherein the first wing portion comprises a medial portion adjacent to the lighting panel and a lateral portion opposite to the medial portion, and wherein at the first end of the first wing portion the lateral portion is configured to interlock with the first end cap and at the second end of the first wing portion the lateral portion is configured to interlock with the second end cap.

4. The troffer lighting system of claim 3, wherein the first wing portion comprises:
a first locking tab at the lateral portion of the first end of the first wing portion; and
a second locking tab at the lateral portion of the second end of the first wing portion;
wherein the first locking tab is configured to engage a slot defined in the first end cap and the second locking tab is configured to engage a slot defined in the second end cap.

5. The troffer lighting system of claim 2, further comprising a first locking screw configured to couple the lighting panel and the first end cap.

6. The troffer lighting system of claim 5, further comprising a second locking screw configured to couple the lighting panel and the second end cap.

7. The troffer lighting system of claim 1, wherein the lighting panel includes a channel and the second wing portion includes a coupler having a connector coupled to the channel and being slidable therein.

8. The troffer lighting system of claim 7, wherein the channel includes a first leg connected to a second leg by a transition portion, the first leg being below the second leg, and wherein the connector is disposed within the first leg when the troffer lighting system is in the closed position and the hinge is disposed within the second leg when the second wing portion is in the open position.

9. The troffer lighting system of claim 8, wherein the first leg and the second leg are parallel to each other.

10. The troffer lighting system of claim 1, further comprising a locking mechanism, wherein with the locking mechanism in a first configuration the second wing portion is able to rotate with respect to the lighting panel, and wherein with the locking mechanism in a second configuration the second wing portion is prevented from rotating with respect to the lighting panel.

11. The troffer lighting system of claim 10, wherein the locking mechanism includes a lock rotatably coupled to the second wing portion, the lock including an arm configured to engage the lighting panel to prevent relative rotation of the second wing portion.

12. A method of installing a troffer lighting system in a drop ceiling, comprising the steps of:
connecting a first end cap to a first end of a lighting panel;
connecting the first end cap to a first wing portion fixedly coupled to the lighting panel;
mounting a second end cap into a grid of the drop ceiling;
connecting a second end of the lighting panel to the second end cap;
rotating a second wing portion from a closed position to an open position so as to engage the second wing portion with the first end cap and the second end cap; and
connecting a lens to the lighting system.

13. The method of claim 12, wherein connecting the first end cap to the first end of the lighting panel includes coupling the lighting panel to the first end cap with a first locking screw.

14. The method of claim 13 wherein connecting the second end cap to the second end of the lighting panel includes coupling the lighting panel to the second end cap with a second locking screw.

15. The method of claim 12, further comprising moving a locking mechanism from a first configuration to a second configuration so as to prevent rotation of the second wing portion with respect to the lighting panel.
